(19) United States
(12) Patent Application Publication
(10) Pub. No.: US 2024/0155340 A1
(43) Pub. Date: May 9, 2024

(54) METHOD AND SYSTEM FOR HANDLING KEY DISTRIBUTION FOR MULTICAST AND BROADCAST SERVICES IN WIRELESS NETWORK

(71) Applicant: SAMSUNG ELECTRONICS CO., LTD., Suwon-si, Gyeonggi-do (KR)

(72) Inventors: Rajavelsamy Rajadurai, Bangalore (IN); Vinay Kumar Shrivastava, Bangalore (IN)

(21) Appl. No.: 18/547,149

(22) PCT Filed: Feb. 18, 2022
(86) PCT No.: PCT/KR2022/002434

§ 371 Date: Aug. 18, 2023

(30) Foreign Application Priority Data
Feb. 20, 2021 (IN) 202141007201
Feb. 20, 2021 (IN) 202141007202
Feb. 10, 2022 (IN) 202141007201

(51) Int. Cl. H04W 12/0431; H04W 4/06; H04W 12/033; H04W 12/041; H04W 12/75; H04W 12/76; H04W 76/40

(52) U.S. Cl. CPC H04W 12/0431; H04W 4/06; H04W 12/033; H04W 12/041; H04W 12/75; H04W 12/76; H04W 76/40

(57) ABSTRACT

The disclosure relates to a 5G or 6G communication system for supporting a higher data transmission rate. Accordingly, the embodiments herein provide a method for handling key distribution for multicast and broadcast services (MBS) in a wireless network. The method includes sending, by an application function (AF) server (100), an MB session announcement message to the UE (300) in the wireless network, where the MB session announcement message includes the TMGI and the HL MC address. Further, the method includes generating, by the AF server (100), the sessionkey (K_{MBS}) for the TMGI and the HL MC address, where the sessionkey (K_{MBS}) is provided to the UE (300) and the plurality of network entities (200). Further, the method includes protecting, by the AF server (100), a MBS traffic associated with the UE (300) and the plurality of network entities (200) using the generated session key (K_{MBS}).

### TECHNICAL FIELD

The present disclosure relates to a wireless network, and more specifically related to a method and a system for handling key distribution for multicast and broadcast services (MBS) in the wireless network.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

In general, 3^{rd} generation partnership project (3GPP) system is currently considering enhancements to 5G system architecture to provide general multicast-broadcast services (MBS). In order to securely transmit data to a given set of users, potential security requirements and solutions for providing the MBS must be defined. A goal of the 5G system is to enable general MBS, such as public safety, vehicle-to-everything (V2X) applications, group communications, and internet of things (IoT) applications, among others.

While security for multicast/broadcast traffic can still be supported at an application layer, it is necessary to consider security provided natively by the 5G system for following reasons. The MBS that lack application-level security (e.g., due to protocol overhead) but want to leverage the security provided by the 5G system, such as the MBS provided by operators (e.g., for IoT devices). As a result, MBS protection must be considered independently of the application layer protection.

The MBS include a concept of a point-to-multipoint (PTM) service into the 3GPP system. MBS traffic is routed through the 5G system from an application service provider(s) to multiple user equipment(s) (UEs). The MBS traffic must be protected to mitigate potential attacks in order to securely transmit data to a given set of users/UEs. Keys for MBS traffic protection are required as the fundamental security basis. The keys for protecting the MBS traffic are one-to-many in comparison to user equipment (UE) keys. When a UE joins an MBS session, only authorized user(s)/UE(s) are able to receive the keys delivered by a key generator for the MBS traffic protection. The UEs may also leave or be compromised during the MBS session. If the keys used to protect the MBS traffic are not kept confidential, an attacker can use the 3GPP system to gain “free access” to the MBS.

If the keys used to protect the MBS traffic are not integrity or anti-replay protected, the authorized user(s)/UE(s) may be unable to properly acquire the MBS traffic. If the keys used to protect the MBS traffic cannot be updated, then the following problems may occur: If the UE(s) in a group left, then the UE(s) may be able to access content after leaving the group, and when the UE(s) joins the group, then the UE(s) may be able to access previous content. If one of the UE(s) in the group is malicious, then malicious UE(s) may be able to inject fake content. Thus, it is desired to provide a useful alternative for handling key distribution for the MBS.

### DISCLOSURE OF INVENTION

### Technical Problem

The principal object of the embodiments herein is to provide a key distribution for multicast and broadcast services (MBS) in a 5G system (5GS). The point-to-multipoint (PTM) or point-to-point (PTP) MBS data traffic needs to be protected to mitigate potential attacks like service theft. The proposed method defines a method and a system to generate a security credential(s) required to receive and protect the MBS data traffic and securely distribute the generated key to intended user equipment (UE) to obtain the MBS securely.

Another object of the embodiments is to generate an MBS session security context data and distribute over a control plane signaling by one of: a next generation radio access network (NG-RAN) (for illustrative purposes next generation nodeb (gNB)), an application function (for illustrative purposes MBS application server), and a network entity in a 5G core network (for illustrative purposes session management function (SMF)) to the UE.

### Solution to Problem

Accordingly, the embodiments herein provide a method for handling key distribution for multicast and broadcast services (MBS) in a wireless network. The method includes sending, by an application function (AF) server, a multicast and broadcast (MB) session announcement message to a user equipment (UE) in the wireless network, where the MB session announcement message includes a temporary mobile group identity (TMGI) and a higher layer IP multicast address (HL MC Address). Further, the method includes generating, by the AF server, a session key (K_{MBS}) for the TMGI and the HL MC address, where the session key (K_{MBS}) is provided to the UE and a plurality of network entities. Further, the method includes protecting, by the AF server, a MBS traffic associated with the UE and the plurality of network entities based on the generated session key (K_{MBS}).

In an embodiment, the plurality of network entities includes an NG radio access network (NG-RAN), an access and mobility management function (AMF), an MB-session management function (MB-SMF), an MB-user plane function (MB-UPF), a policy control function (PCF), a network exposure function (NEF), and an NF repository function (NRF)

In an embodiment, the session key (K_{MBS}) includes generating, by a key management server (K_{MBS}), the K_{MBS}, where the KMS is co-located with one of the NEF, the AMF, the MB-SMF, the AF, and a standalone entity within 5G-core (5GC) or outside of the 5GC.

In an embodiment, the KMS is discoverable by the plurality of network entities using the NRF, and the plurality of network entities obtain the session key (K_{MBS}) from the KMS by exchanging a key request message and a key response message.

In an embodiment, the UE and the plurality of network entities generates a plurality of keys using the session key (K_{MBS}) to secure the MBS traffic, and the plurality of keys includes an MBS RAN specific key (K_{MBS-RAN}), an MBS integrity key (K_{MBSint}), an MBS encrypted key (K_{MBSenc}), and an MBS security key (K_{MBSsec}).

In an embodiment, the K_{MBS-RAN} is generated by the UE and/or the NG-RAN from the session key (K_{MBS}) and a plurality of parameters, and the plurality of parameters includes the TMGI, a count of MBS, a physical cell identifier (PCI), a down link (DL) frequency, and a random number (RAND).

In an embodiment, the K_{MBSint} is generated by the UE and/or the NG-RAN from the session key (K_{MBS}), the K_{MBS-RAN}, and/or a plurality of parameters for MBS traffic protection using a specific integrity protocol, and the plurality of parameters includes the TMGI, the count of MBS, the PCI, the DL frequency, and the RAND, a protocol distinguisher value, a protocol identifier value, a Key index, and an MC address.

In an embodiment, the K_{MBSenc} is generated by the UE and/or the NG-RAN from the session key (K_{MBS}), the K_{MBS-RAN}, and/or a plurality of parameters for MBS traffic protection using a specific encryption protocol.

In an embodiment, the K_{MBSsec} is generated by the UE and/or the NG-RAN from the session key (K_{MBS}), the K_{MBS-RAN}, and/or a plurality of parameters for MBS traffic protection using a specific security protocol.

In an embodiment, the method includes updating, by the AF server, the session key (K_{MBS}) for an ongoing MBS session and sending, by the AF server, a message to the NG-RAN through one or more network entity of the plurality of network entities, where the message indicates that the session key (K_{MBS}) is changed for ongoing MBS session and the NG-RAN sends the message to the UE in one or more a system information block (SIB), a MBS multicast control channel (MCCH) information message, and a RRC reconfiguration message.

In an embodiment, the message includes a new TMGI, a new session key index for corresponding TMGI, and selected protocol for corresponding TMGI.

In an embodiment, the method includes determining, by the AF server, whether security protection applies to an ongoing MBS session and an indication is present in an MBS security context, wherein the indication indicates that whether or not security protection applies to the ongoing MBS session, inserting, by the AF server (100), security related parameters in the MBS security context in response to determining that the security protection applies to the ongoing MBS session and the indication is present in an MBS security context, wherein the indication indicates that the security protection applies to the ongoing MBS session, and sending, by the AF server, the MBS security context to the UE through one or more network entity of one or more network entity of the plurality of network entities.

In an embodiment, the method includes determining, by the AF server, whether security protection applies to an ongoing MBS session, and sending, by the AF server, the MBS security context to the UE through one or more network entity of the plurality of network entities in response to determining that the security protection applies to the ongoing MBS session.

In an embodiment, the method includes storing, by the UE, the MBS security context in a memory, when the UE is in an idle mode or a connection-mode or switch between modes.

In an embodiment, the method includes sending, by a network entity of the plurality of network entities, an MBS counter check message to the UE, where the MBS counter check message comprises an amount of data (e.g. PDCP count values) sent or received on each DRB and/or an amount of data sent on each MRB, where the network entity comprises the NG-RAN, receiving, by the network entity, an MBS counter check response message from the UE, where the MBS counter check response message includes an amount of data received or sent on each established data radio bearer (DRB) and/or an amount of data received on each MBS radio bearer (MRB) from the UE, determining, by the network entity, whether the amount of data sent or received on each DRB and/or each MRB by the network entity is the same as the amount of data received or sent on each DRB and/or the amount of data received on each MRB by the UE, and detecting, by the network entity, that a man in the middle attack (packet insertion by an intruder) in response to determining that the amount of data sent or received on each DRB and/or the amount of data sent on each MRB by the network entity is not the same as the amount of data received or sent on each DRB and/or the amount of data received on each MRB by the UE and re-establish the MBS. MBS bearer can be one of PTM bearer, PTP bearer or a split MBS bearer (i.e. a combination of PTM and PTP).

In an embodiment, the method includes selecting, by the network entity, randomly limited number of UEs from a plurality of UEs accessing an ongoing MBS session, wherein the network entity comprises the NG-RAN, and sending, by the network entity, an MBS counter check message to the selected UE, as to restrict the plurality of UEs providing responses. Further, in an embodiment, the limited number of UEs may pertain to the set of RRC_CONNECTED state UEs i.e. UEs in RRC_INACTIVE state receiving MBS multicast services are not considered.

In an embodiment, the method includes sending, by the UE, an MBS counter check message to a network entity of the plurality of network entities, where the MBS counter check message comprises an amount of data (e.g. TMGIs, MRB IDs of the ongoing MBS sessions) sent or received on each DRB and/or received on each MRB, and where the network entity comprises the NG-RAN, receiving, by the UE, an MBS counter check response message from the network entity, where the MBS counter check response message comprises an amount of data received or sent on each DRB and/or sent on each MRB by the network entity, determining, by the UE, whether the amount of data sent or received on each DRB and/or received on each MRB by the UE is the same as the amount of data received or sent by the network entity on each DRB and/or sent on each MRB by the network entity, and detecting, by the UE, that a man in the middle attack in response to determining that the amount of data sent or received on each DRB and/or received on each MRB by the UE is not the same as the amount of data received or sent on each DRB and/or sent on each MRB by the network entity and re-establish the MBS.

Accordingly, the embodiments herein provide the AF server for handling the key distribution for the MBS in the wireless network. The AF server includes an MBS session key controller coupled with a processor and a memory. The MBS session key controller sends the MB session announcement message to the UE in the wireless network, where the MB session announcement message includes the TMGI and the HL MC address. Further, the MBS session key controller generates the session key (KMBS) for the TMGI and the HL MC address, where the session key (KMBS) is provided to the UE and the plurality of network entities. Further, the MBS session key controller protects the MBS traffic associated with the UE and the plurality of network entities using the generated session key (KMBS).

Accordingly, the embodiments herein provide the network entity for handling the key distribution for the MBS in the wireless network. The network entity includes an MBS session key controller coupled with a processor and a memory. The MBS session key controller receives the session key (K_{MBS}) from the AF server. Further, the MBS session key controller generates the plurality of keys using the session key (K_{MBS}) to protect the MBS traffic, and the plurality of keys includes the MBS RAN specific key (K_{MBS-RAN}), the MBS integrity key (K_{MBSint}), the MBS encrypted key (K_{MBSenc}), and the MBS security key (K_{MBSsec}).

Accordingly, the embodiments herein provide the UE for handling the key distribution for the MBS in the wireless network. The UE includes an MBS session key controller coupled with a processor and a memory. The MBS session key controller receives the session key (K_{MBS}) from the AF server. Further, the MBS session key controller generates the plurality of keys using the session key (K_{MBS}) to protect the MBS traffic, and the plurality of keys includes the MBS RAN specific key (K_{MBS-RAN}), the MBS integrity key (K_{MBSint}), the MBS encrypted key (K_{MBSenc}), and the MBS security key (K_{MBSsec}).

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein, and the embodiments herein include all such modifications.

### BRIEF DESCRIPTION OF DRAWINGS

The present disclosure is illustrated in the accompanying drawings, throughout which like reference letters indicate corresponding parts in the various figures. The embodiments herein will be better understood from the following description with reference to the drawings, in which:

FIG. 1 illustrates a schematic showing delivery methods for 5G MBS, according to embodiments as disclosed herein;

FIG. 2A illustrates a block diagram of an application function (AF) server for handling key distribution in the 5G MBS, according to embodiments as disclosed herein;

FIG. 2B illustrates a block diagram of a network entity for handling the key distribution in the 5G MBS, according to embodiments as disclosed herein;

FIG. 2C illustrates a block diagram of a user equipment (UE) for handling the key distribution in the 5G MBS, according to embodiments as disclosed herein;

FIG. 3 is a flow diagram illustrating a method for handling key distribution in the 5G MBS, according to embodiments as disclosed herein;

FIGS. 4A and 4B illustrate a scenario in which an MBS session security context is generated and distributed by the network entity in a 5G Core network (for illustrative purposes SMF) to the UE, according to embodiments as disclosed herein;

FIGS. 5A and 5B illustrate a scenario in which the MBS session security context is generated and distributed by an NG-RAN (for illustrative purposes gNB) to the UE, according to embodiments as disclosed herein;

FIGS. 6A and 6B illustrate a scenario in which the MBS session security context is generated and distributed by an application function (for illustrative purposes the AF server) to the UE, according to embodiments as disclosed herein;

FIG. 7A illustrates an MBS security key hierarchy generation for a point-to-multipoint (PTM) scenario, according to embodiments as disclosed herein;

FIG. 7B illustrates an MBS security key derivation scheme for a point-to-point (PTP) scenario, according to embodiments as disclosed herein;

FIG. 8 illustrates a difference between a Legacy PDCP entity and a new PDCP entity, according to embodiments as disclosed herein;

FIG. 9 is a sequence diagram illustrating an MBS counter check procedure between the UE and the network entity, according to embodiments as disclosed herein;

FIG. 10 is another sequence diagram illustrating the MBS counter check procedure between the UE and the network entity, according to embodiments as disclosed herein; and

FIGS. 11 and 12 are sequence diagrams illustrating a security mode command procedure between the UE and the network entity is to activate AS security upon an RRC connection establishment, according to embodiments as disclosed herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Throughout this document, the term “MBS session security context data”, “MBS security context data”, “MBS security context” means the same and are used interchangeably. Throughout this document, the term “MBS session security context data” is defined as one of: session key, key index, and selected mechanisms. Throughout this document, the term “MBS session security context data” is defined as one of: MBS session key (K_{MBS}), MBS RAN specific key (K_{MBS-RAN}), secret seed random number (RAND), and/or hyper frame number. (HFN)), key index and selected mechanisms. Throughout this document, the term “AF’ and “AF server’ means the same and are used interchangeably. Throughout this document, the term “network entity’ and “plurality of network entities’ means the same and are used interchangeably.

Accordingly, the embodiments herein provide a method for handling key distribution for multicast and broadcast services (MBS) in a wireless network. The method includes sending, by an application function (AF) server, a multicast and broadcast (MB) session announcement message to a user equipment (UE) in the wireless network, where the MB session announcement message includes a temporary mobile group identity (TMGI) and a higher layer IP multicast address (HL MC Address). Further, the method includes generating, by the AF server, a session key (K_{MBS}) for the TMGI and the HL MC address, where the session key (K_{MBS}) is provided to the UE and a plurality of network entities. Further, the method includes protecting, by the AF server, a MBS traffic associated with the UE and the plurality of network entities using the generated session key (K_{MBS}).

Accordingly, the embodiments herein provide the network entity for handling the key distribution for the MBS in the wireless network. The network entity includes an MBS session key controller coupled with a processor and a memory. The MBS session key controller receives the session key (K_{MBS}) from the AF server. Further, the MBS session key controller generates the plurality of keys using the session key (K_{MBS}) to protect the MBS traffic, and the plurality of keys includes the MBS RAN specific key (K_{MBS-RAN}), the MBS integrity key (K_{MBSint}), the MBS encrypted key (K_{MBSenc}), and the MBS security key (K_{MBSsec}).

Accordingly, the embodiments herein provide the UE for handling the key distribution for the MBS in the wireless network. The UE includes an MBS session key controller coupled with a processor and a memory. The MBS session key controller receives the session key (K_{MBS}) from the AF server. Further, the MBS session key controller generates the plurality of keys using the session key (K_{MBS}) to protect the MBS traffic, and the plurality of keys includes the MBS RAN specific key (K_{MBS-RAN}), the MBS integrity key (K_{MBSint}), the MBS encrypted key (K_{MBSenc}), and the MBS security key (K_{MBSsec}).

Unlike existing methods and systems, the proposed method allows the AF server, the UE and the network entity to provide a Key distribution for multicast and broadcast services (MBS) in a 5G system (5GS). The point-to-multipoint (PTM) or point-to-point (PTP) MBS data traffic needs to be protected to mitigate potential attacks like service theft. The proposed method defines a method and system to generate a security credential(s) required to receive and protect the MBS data traffic and securely distribute the generated key to intended user equipment (UE) to obtain the MBS securely.

Unlike existing methods and systems, the proposed method allows the AF server, the UE and the network entity to generate an MBS session security context data and distribute over a control plane signaling by one of: NG radio access network (NG-RAN) (for illustrative purposes next generation NodeB (gNB)), application function (for illustrative purposes MBS Application Server), a network entity in 5G Core network (for illustrative purposes session management function (SMF)) to the UE.

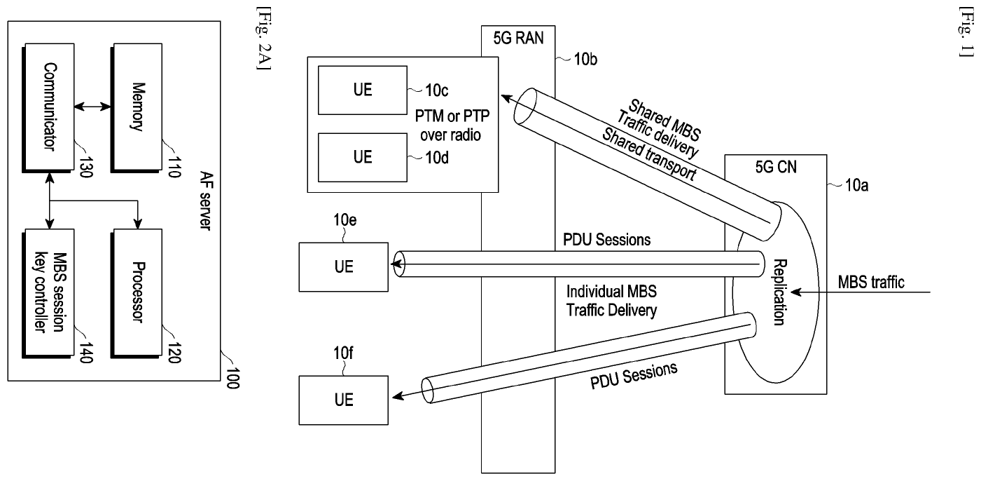

Referring now to the drawings, and more particularly to FIGS. 1 through 12, where similar reference characters denote corresponding features consistently throughout the figures, there are shown preferred embodiments.

FIG. 1 illustrates a schematic showing delivery methods for 5G MBS, according to embodiments as disclosed herein. The 5G MBS includes a plurality of network entities, for example, a 5G core network (CN) (10a), a 5G radio access network (RAN) node (10b), and one or more user equipment (UE) (10c, 10d, 10e, and 10f).

A 5G CN-individual MBS traffic delivery method and a 5G CN-shared MBS traffic delivery method are proposed for the 5G MBS from a viewpoint of the 5G CN (10a). According to the 5G CN-individual MBS traffic delivery method, the 5G CN (10a) receives a single copy of MBS data packets and delivers separate copies of those MBS data packets to individual UEs (e.g. 10e, 10f) via per-UE protocol data unit (PDU) sessions, while according to the 5G CN-shared MBS traffic delivery method, the 5G CN (10a) receives the single copy of MBS data packets and delivers the single copy of those MBS data packets to the 5G RAN node (10b), which then delivers those MBS data packets to one or multiple UEs (e.g. 10e). The 5G RAN node (10b) delivers the MBS data packets to the UEs (e.g. 10c, 10d) using either point-to-point (PTP) delivery or point-to-multipoint (PTM) delivery.

The MBS traffic needs to be delivered from a single data source (application service provider) to multiple UEs (e.g. 10c). Depending on many factors, multiple delivery methods may be used to deliver the MBS traffic in the 5G MBS. For clarity, delivery methods are now referred to as unicast/multicast/broadcast but as describes the term “unicast delivery” refers to a mechanism by which application data and signaling between the UE (e.g. 10c) and an application server (not shown in FIG. 1) are delivered using the PDU Session within a 3GPP network and using individual UE (e.g. 10c) and the application server addresses (e.g. IP addresses) between the 3GPP network and the application server. It is not equivalent to the 5G CN-individual MBS traffic delivery method defined in this clause.

From a view point of the 5G CN (10a), two delivery methods listed below are possible for MBS multicast service.
a. 5G CN-individual MBS traffic delivery method: the 5G CN (10a) receives the single copy of the MBS data packets and delivers separate copies of those MBS data packets to individual UEs (e.g. 10e) via each UE PDU sessions. Hence for each such UE, one PDU session is required to be associated with a multicast session.
b. 5G CN-shared MBS traffic delivery method: the 5G CN (10a) receives the single copy of the MBS data packets and delivers the single copy of those MBS data packets to the 5G RAN node (10b), which then delivers them to one or multiple UEs (e.g. 10c).

If the 5G CN-individual MBS traffic delivery method is supported, a same received the single copy of the MBS data packets by the 5G CN (10a) may be delivered via both the 5G CN-individual MBS traffic delivery method for some UE(s) (e.g. 10e) and the 5G CN-shared MBS traffic delivery method for other UEs (e.g. 10c).

From a viewpoint of the 5G RAN node (10b), (in the case of the shared delivery) two delivery methods are listed below, which are available for the transmission of MBS data packets flows over radio.
a. Point-to-Point (PTP) delivery method: the 5G RAN node (10b) delivers separate copies of the MBS data packets over the radio to individual UE (e.g. 10c).
b. Point-to-Multipoint (PTM) delivery method: the 5G RAN node (10b) delivers a single copy of MBS data packets over the radio to a set of UEs (e.g. 10c).

The 5G RAN node (10b) may use a combination of the PTP and PTM to deliver the MBS data packets to the UEs (e.g. 10c), which is valid from same UE perspective as well.

As depicted in FIG. 1, the PTP/PTM delivery (with the 5G CN (10a) shared delivery method) and the 5G CN-individual MBS traffic delivery method may be used at the same time for a multicast MBS session, which is valid from two different UEs perspective.

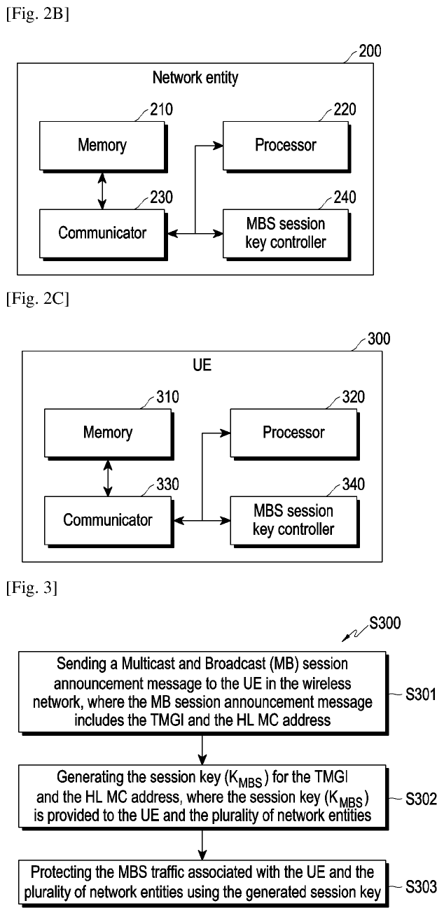

FIG. 2A illustrates a block diagram of an application function (AF) server (100) for handling key distribution in the 5G MBS, according to embodiments as disclosed herein.

In an embodiment, the AF server (100) includes a memory (110), a processor (120), a communicator (130), and an MBS session key controller (140).

In an embodiment, the memory (110) stores various keys (e.g. a session key (K_{MBS}), an MBS RAN specific key (K_{MBS-RAN}), an MBS integrity key (K_{MBSint}), an MBS encrypted key (K_{MBSenc}), and an MBS security key (K_{MBSsec})). The memory (110) stores instructions to be executed by the processor (120). The memory (110) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (110) may, in some examples, be considered a non-transitory storage medium. The term “non-transitory” may indicate that the storage medium is not embodied in a carrier wave or a propagated signal. However, the term “non-transitory” should not be interpreted that the memory (110) is non-movable. In some examples, the memory (110) can be configured to store larger amounts of information than the memory. In certain examples, a non-transitory storage medium may store data that can, over time, change (e.g., in random access memory (RAM) or cache). The memory (110) can be an internal storage unit or it can be an external storage unit of the AF server (100), a cloud storage, or any other type of external storage.

The processor (120) communicates with the memory (110), the communicator (130), and the MBS session key controller (140). The processor (120) is configured to execute instructions stored in the memory (110) and to perform various processes. The processor (120) may include one or a plurality of processors, maybe a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

The communicator (130) is configured for communicating internally between internal hardware components and with external devices (e.g. eNodeB, gNodeB, server, etc.) via one or more networks (e.g. Radio technology). The communicator (130) includes an electronic circuit specific to a standard that enables wired or wireless communication.

The MBS session key controller (140) is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

In an embodiment, the MBS session key controller (140) sends a multicast and broadcast (MB) session announcement message to a (UE (300) in the wireless network, where the MB session announcement message includes a temporary mobile group identity (TMGI) and a higher layer IP multicast address (HL MC address). Further, the MBS session key controller (140) generates a session key (K_{MBS}) for the TMGI and the HL MC address, where the session key (K_{MBS}) is provided to the UE (300) and a plurality of network entities (200) (not shown in FIG. 2A). The plurality of network entities (200) includes an NG radio access network (NG-RAN) (200a), an access and mobility management function (AMF) (200b), an MB-session management function (MB-SMF) (200c), an MB-user plane function (MB-UPF) (200d), a policy control function (PCF) (200e), a network exposure function (NEF) (200f), and an NF repository function (NRF) (200g). Further, the MBS session key controller (140) protects a MBS traffic associated with the UE (300) and/or the plurality of network entities (200) using the generated session key (K_{MBS}).

In an embodiment, the session key (K_{MBS}) is generated by a key management server (K_{MBS}). The KMS is co-located with one of the NEF (200f), the NG-RAN (200a), the AMF (200b), the MB-SMF (200c), the AF (100), and a standalone entity within a 5G-Core (5GC) or outside of the 5GC.

In an embodiment, the KMS is discoverable by the plurality of network entities (200) using the NRF (200g), and the plurality of network entities (200) obtain the session key (K_{MBS}) from the KMS by exchanging a key request message and a key response message.

Further, the MBS session key controller (140) updates the session key (K_{MBS}) for an ongoing MBS session. Further, the MBS session key controller (140) sends a message to the NG-RAN (200a) through one or more network entity of the plurality of network entities (200), where the message indicates that the session key (K_{MBS}) is changed for ongoing MBS session and the NG-RAN (200a) sends the message to the UE (300) in one or more a System Information Block (SIB), a MBS multicast control channel (MCCH) information message, and a RRC reconfiguration message. The message includes one of a new TMGI, a new session key index for corresponding TMGI, and selected protocol for corresponding TMGI.

Further, the MBS session key controller (140) determines whether security protection applies to the ongoing MBS session and an indication is present in an MBS security context, wherein the indication indicates that whether or not security protection applies to the ongoing MBS session. Further, the MBS session key controller (140) inserts security related parameters in the MBS security context in response to determining that the security protection applies to the ongoing MBS session and the indication is present in an MBS security context, wherein the indication indicates that the security protection applies to the ongoing MBS session. Further, the MBS session key controller (140) sends the MBS security context to the UE (300) through one or more network entity of the plurality of network entities (200).

Further, the MBS session key controller (140) determines whether security protection applies to the ongoing MBS session and sends the MBS security context to the UE (300) through one or more network entity of the plurality of network entities (200) in response to determining that the security protection applies to the ongoing MBS session.

Although the FIG. 2A shows various hardware components of the AF server (100) but it is to be understood that other embodiments are not limited thereon. In other embodiments, the AF server (100) may include less or more number of components. Further, the labels or names of the components are used only for illustrative purpose and does not limit the scope of the present disclosure. One or more components can be combined together to perform same or substantially similar function to handle the key distribution for the MBS in the wireless network.

FIG. 2B illustrates a block diagram of a network entity (200) for handling the key distribution in the 5G MBS, according to embodiments as disclosed herein.

In an embodiment, the network entity (200) includes a memory (210), a processor (220), a communicator (230), and an MBS session key controller (240).

In an embodiment, the memory (210) stores various keys (e.g. the session key (K_{MBS}), the K_{MBS-RAN}, the K_{MBSint}, the K_{MBSenc}, and the K_{MBSsec}). The memory (210) stores instructions to be executed by the processor (220). The memory (210) may include nonvolatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (210) may, in some examples, be considered a non-transitory storage medium. The term “non-transitory” may indicate that the storage medium is not embodied in a carrier wave or a propagated signal. However, the term “non-transitory” should not be interpreted that the memory (210) is non-movable. In some examples, the memory (210) can be configured to store larger amounts of information than the memory. In certain examples, a non-transitory storage medium may store data that can, over time, change (e.g., in RAM or cache). The memory (210) can be an internal storage unit or it can be an external storage unit of the network entity (200), a cloud storage, or any other type of external storage.

The processor (220) communicates with the memory (210), the communicator (230), and the MBS session key controller (240). The processor (220) is configured to execute instructions stored in the memory (210) and to perform various processes. The processor (220) may include one or a plurality of processors, maybe a general-purpose processor, such as a CPU, an AP, or the like, a graphics-only processing unit such as a GPU, a VPU, and/or an AI dedicated processor such as a NPU.

The communicator (230) is configured for communicating internally between internal hardware components and with external devices (e.g., AF server, UE, etc.) via one or more networks (e.g. Radio technology). The communicator (230) includes an electronic circuit specific to a standard that enables wired or wireless communication.

The MBS session key controller (240) is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

In an embodiment, the MBS session key controller (240) receives the session key (K_{MBS}) from the AF server (100). Further, the MBS session key controller (240) generates a plurality of keys using the session key (K_{MBS}) to protect the MBS traffic, and the plurality of keys includes an MBS RAN specific key (K_{MBS-RAN}), an MBS integrity key (K_{MBSint}), an MBS encrypted key (K_{MBSenc}), and an MBS security key (K_{MBSsec}).

In an embodiment, the K_{MBS-RAN} is generated by the NG-RAN (200a) from the session key (K_{MBS}) and a plurality of parameters, and the plurality of parameters includes the TMGI, a count of MBS, a physical cell id (PCI), a down link (DL) frequency, and a random number (RAND).

In an embodiment, the K_{MBSint} is generated by the NG-RAN (200a) from the session key (K_{MBS}), the K_{MBS-RAN}, and a plurality of parameters for MBS traffic protection using a specific integrity protocol, and the plurality of parameters includes the TMGI, the count of MBS, the PCI, the DL frequency, and the RAND, a protocol distinguisher value, a protocol identifier value, a Key index, an MC address.

In an embodiment, the K_{MBSenc} is generated by the NG-RAN (200a) from the session key (K_{MBS}), the K_{MBS-RAN}, and the plurality of parameters for MBS traffic protection using a specific encryption protocol.

In an embodiment, the K_{MBSsec} is generated by the NG-RAN (200a) from the session key (K_{MBS}), the K_{MBS-RAN}, and the plurality of parameters for MBS traffic protection using a specific security protocol.

Further, the MBS session key controller (240) sends an MBS counter check message to the UE (300), where the MBS counter check message includes an amount of data (e.g. PDCP count value) sent or received on each established DRB and/or an amount of data sent on each MRB, where the network entity (200) includes the NG-RAN (200a). Further, the MBS session key controller (240) receives an MBS counter check response message from the UE (300), where the MBS counter check response message includes an amount of data received or sent on each DRB and/or an amount of data received on each MRB from the UE (300). Further, the MBS session key controller (240) determines whether the amount of data sent or received on each DRB and/or each MRB by the network entity (200) is same as the amount of data received or sent on each DRB and/or the amount of data received on each MRB by the UE (300). Further, the MBS session key controller (240) detects that a man in the middle attack (packet insertion by an intruder) in response to determining that the amount of data sent or received on each DRB and/or the amount of data received on each MRB by the network entity (200) is not same as the amount of data received or sent on each DRB and/or the amount of data received on each MRB by the UE (300) and re-establishes the MBS. MBS bearer can be one of PTM bearer, PTP bearer or a split MBS bearer (i.e. a combination of PTM and PTP)

Further, the MBS session key controller (240) selects randomly limited number of UEs from a plurality of UEs (300) accessing the ongoing MBS session, wherein the network entity comprises the NG-RAN (200a), and sends an MBS counter check message to the selected UE, as to restrict the plurality of UEs (300) providing responses. Further, in an embodiment, the limited number of UEs may pertain to the set of RRC_CONNECTED state UEs i.e. UEs in RRC_INACTIVE state receiving MBS multicast services are not considered.

Although the FIG. 2B shows various hardware components of the network entity (200) but it is to be understood that other embodiments are not limited thereon. In other embodiments, the network entity (200) may include less or more number of components. Further, the labels or names of the components are used only for illustrative purpose and does not limit the scope of the present disclosure. One or more components can be combined together to perform same or substantially similar function to handle the key distribution for the MBS in the wireless network.

FIG. 2C illustrates a block diagram of the UE (300) for handling the key distribution in the 5G MBS, according to embodiments as disclosed herein. Examples of the UE (300) include, but not limited to a smartphone, a tablet computer, a personal digital assistance (PDA), an internet of things (IoT) device, a wearable device, etc.

In an embodiment, the UE (300) includes a memory (310), a processor (320), a communicator (330), and an MBS session key controller (340).

In an embodiment, the memory (310) stores various keys (e.g. the session key (K_{MBS}), the K_{MBS} RAN, the K_{MBSint}, the K_{MBSenc}, and the K_{MBSsec}). The memory (310) stores instructions to be executed by the processor (320). The memory (310) may include nonvolatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (310) may, in some examples, be considered a non-transitory storage medium. The term “non-transitory” may indicate that the storage medium is not embodied in a carrier wave or a propagated signal. However, the term “non-transitory” should not be interpreted that the memory (310) is non-movable. In some examples, the memory (310) can be configured to store larger amounts of information than the memory. In certain examples, a non-transitory storage medium may store data that can, over time, change (e.g., in RAM or cache). The memory (310) can be an internal storage unit or it can be an external storage unit of the UE (300), a cloud storage, or any other type of external storage.

The processor (320) communicates with the memory (310), the communicator (330), and the MBS session key controller (340). The processor (320) is configured to execute instructions stored in the memory (310) and to perform various processes. The processor (320) may include one or a plurality of processors, maybe a general-purpose processor, such as a CPU, an AP, or the like, a graphics-only processing unit such as a GPU, a VPU, and/or an AI dedicated processor such as a NPU.

The communicator (330) is configured for communicating internally between internal hardware components and with external devices (e.g., AF server, network entity, etc.) via one or more networks (e.g. Radio technology). The communicator (330) includes an electronic circuit specific to a standard that enables wired or wireless communication.

The MBS session key controller (340) is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

In an embodiment, the MBS session key controller (340) receives the session key (K_{MBS}) from the AF server (100). Further, the MBS session key controller (340) generates the plurality of keys using the session key (K_{MBS}) to protect the MBS traffic, and the plurality of keys includes the K_{MBS-RAN}, the K_{MBSint}, the K_{MBSenc}, and the K_{MBSsec}.

In an embodiment, the K_{MBS-RAN} is generated by the UE (300) from the session key (K_{MBS}) and the plurality of parameters.

In an embodiment, the K_{MBSint} is generated by the UE (300) from the session key (K_{MBS}), the K_{MBS-RAN}, and the plurality of parameters for MBS traffic protection using the specific integrity protocol.

In an embodiment, the K_{MBSenc} is generated by the UE (300) from the session key (K_{MBS}), the K_{MBS-RAN}, and the plurality of parameters for MBS traffic protection using the specific encryption protocol.

In an embodiment, the K_{MBSsec} is generated by the UE (300) from the session key (K_{MBS}), the K_{MBS-RAN}, and the plurality of parameters for MBS traffic protection using the specific security protocol.

Further, the MBS session key controller (340) stores the MBS security context in the memory (310), when the UE (300) is in an idle mode or a connection-mode or switch between modes.

Further, the MBS session key controller (340) sends the MBS counter check message to the network entity (200) of the plurality of network entities (200), where the MBS counter check message comprises the amount of data (e.g. TMGIs, MRB IDs of the ongoing MBS sessions) sent or received on each DRB and/or received on each MRB, and where the network entity (200) comprises the NG-RAN (200a). Further, the MBS session key controller (340) receives the MBS counter check response message from the network entity (200), where the MBS counter check response message comprises the amount of data received or sent on each DRB and/or sent on each MRB from by the network entity (200). Further, the MBS session key controller (340) determines whether the amount of data sent or received on each DRB and/or received on each MRB by the UE (300) is same as the amount of data received or sent on each DRB and/or sent on each MRB by the network entity (200). Further, the MBS session key controller (340) detects that the man in the middle attack in response to determining that the amount of data sent or received on each DRB and/or received on each MRB by the UE (300) is not same as the amount of data received or sent on each DRB and/or sent on each MRB by the network entity (200) and re-establishes the MBS.

Although the FIG. 2C shows various hardware components of the UE (300) but it is to be understood that other embodiments are not limited thereon. In other embodiments, the UE (300) may include less or more number of components. Further, the labels or names of the components are used only for illustrative purpose and does not limit the scope of the present disclosure. One or more components can be combined together to perform same or substantially similar function to handle the key distribution for the MBS in the wireless network.

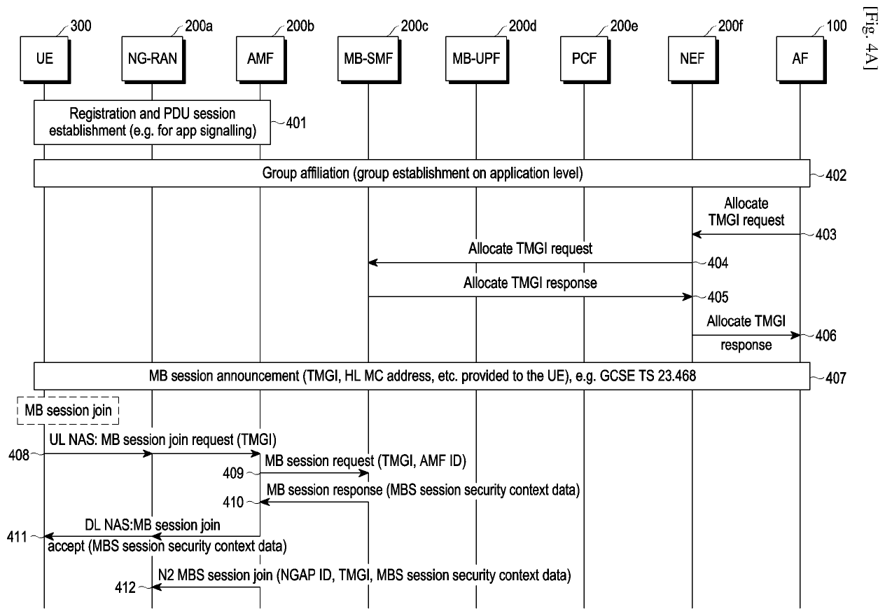

FIG. 3 is a flow diagram (S300) illustrating a method for handling the key distribution in the 5G MBS, according to embodiments as disclosed herein. The AF server (100) performs steps (S301-S303) of the flow diagram (S300) to handle the key distribution in the 5G MBS.

At S301, the method includes sending the MB session announcement message to the UE (300) in the wireless network, where the MB session announcement message includes the TMGI and the HL MC address. At S302, the method includes generating the session key (K_{MBS}) for the TMGI and the HL MC address, where the session key (K_{MBS}) is provided to the UE (300) and the plurality of network entities (200). At S303, the method includes protecting the MBS traffic associated with the UE (300) and the plurality of network entities (200) using the generated session key (K_{MBS}).

The various actions, acts, blocks, steps, or the like in the flow diagram (S300) may be performed in the order presented, in a different order or simultaneously. Further, in some embodiments, some of the actions, acts, blocks, steps, or the like may be omitted, added, modified, skipped, or the like without departing from the scope of the present disclosure.

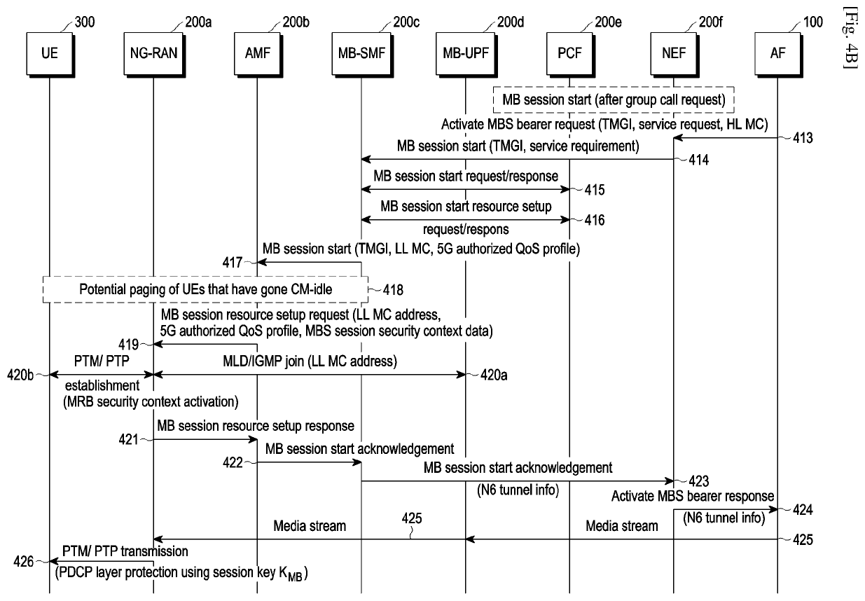

FIGS. 4A and 4B illustrates a scenario in which the MBS session security context is generated and distributed by the network entity (200) in a 5G Core network (for illustrative purposes the SMF (or said MB-SMF (200c))) to the UE (300), according to embodiments as disclosed herein.

At steps 401-402, the UE (300) registers, and establishes a PDU session is established with the network entity (200) (e.g. NG-RAN (200a), AMF (200b)). The UE (300) and the AF (100) use the PDU session e.g. to signal and establish a group on an application-level (according to TS 23.468). If the PDU session is used for application-level signaling in steps 401 and 406, then it (PDU session) manages independently from the MB session. That is, the PDU session does for example not need to be maintained while the UE (300) is receiving multicast content.

At step 403, the AF (100) sends an allocate Temporary Mobile Group Identity (TMGI) request message to the NEF (200f) to request allocation of the TMGI to identify a new group. Optionally, the TMGIs may be pre-allocated in the AF (100) and the 5GC (not shown in FIGS. 4A and 4B). When the pre-allocated TMGI is used, then the pre-allocated TMGI shall be included in the allocate TMGI request (TMGI) message. A combined TMGI allocation and session start on an N33 API interface is assumed to use allocate TMGI request/response and MB session start messages on an N29 interface. The AF (100) may include a new indication “DisablelndividualDelivery” to indicate if the 5GC individual MBS traffic delivery should not be applied for a specific MB Session due to application characteristics.

At step 404, the NEF (200f)/the MB-SMF (200c) selects, based on local configuration, the MB-SMF (200c) (if there are multiple) to handle the group and sends an allocate TMGI request message to the MB-SMF (200c). Optionally, the MBSF makes the TMGI allocation, stores it (TMGI allocation) in the MB session context, and includes the allocated TMGI in the message sending to the MB-SMF (200c). The MBSF may have a pre-configured TMGI range for each MB-SMF (200c). The TMGI range should also be configured/registered in the NRF to allow AMFs to discover which MB-SMF (200c) is controlling an MB session identified by the TMGI. Optionally, the TMGIs may be pre-allocated in the AF (100) and the 5GC e.g. based on Service level agreements (SLAs). When the pre-allocated TMGI is used, then the pre-allocated TMGI shall be included in the allocate TMGI request (TMGI) message. The MB-SMF (200c) or optionally the MBSF shall after local checks (e.g. that it is allowed for pre-allocation and has not already been used) use the provided TMGI if present, and proceed as normal (i.e. store it in the MB session context, etc.). Further, the NEF (200f)/MBSF passes the indication DisableIndividualDelivery (if received) to the MB-SMF (200c).

At step 405, the MB-SMF (200c) allocates the TMGI (optionally pre-allocated TMGI may be used as given in step 404), a lower layer multicast IP address (LL MC address) for N3, and N6 tunnel information and stores the N3, and N6 tunnel information in a new MB session context set to ‘inactive’ state. The MB-SMF (200c) returns the TMGI and the N6 tunnel information to the NEF (200f)/MBSF. If the MB-SMF (200c) makes the TMGI allocation, the MB-SMF (200c) may allocate the TMGI from a preconfigured TMGI range.

In an embodiment, for large networks or redundancy reasons, the NEF (200f)/MBSF might use multiple MB-SMFs (200c) (and MB-UPFs (200d)).

In an embodiment, since the N3 LL MC address is used for 5GS internal transport, it is considered sufficient to allocate the N3 LL MC address at session start, i.e. when resources for the MB session are allocated in different nodes. A one-to-one relationship between N3 LL MC address and MB session is used.

At step 406, the NEF (200f)/MBSF establishes a new MB session context set to the ‘inactive’ state, stores received information, and responds to the AF (100) by sending an allocate TMGI response (TMGI) message. At step 407, an MB session announcement (according to TS 23.468). The AF (100) informs the members in the group of various group info e.g. TMGI, HL MC Address. The HL MC address may be allocated by the AF (100) for the group/TMGI.

Steps 408-412 represent MB session join. At step 408, the UE (300) indicates its interest to join the MB session by sending a UL NAS MB session join request (TMGI) message. The NG-RAN (200a) forwards a NAS message to the AMF (200b). The AMF (200b) stores the TMGI in its UE context.

In an embodiment, the UE (300) always joins the MB session as such. For an MB session (i.e. a TMGI) that has several media streams, the UE (300) may choose to process and present all or a selected set of media streams.

In an embodiment, this solution does for the moment not use the AF (100) based authorization of the UE (300) at session join (e.g. in step 409). Such authorization could potentially cause heavy signaling in the system without being motivated from a security point of view.

In an embodiment, for a moment it is unclear whether authorization of the UE (300) to join the MB session in the 5GC is needed. Authorization on the application layer is considered sufficient. If the requirement to have additional authorization in the 5GC becomes clear in the future, then a solution can be proposed, e.g. the AF (100) provisions a user data repository (UDR) (not shown in FIGS. 4A and 4B) with the necessary info and the UDR provides such info to unified data management (UDM) (not shown in FIGS. 4A and 4B) as subscription data for the AMF (200b) to check. An alternative could be that the UE's authorization is performed at a 5G-multicast and broadcast services (5MBS) feature level, and this can be achieved by including a new authorization parameter for the 5MBS in the subscription data.

Step 403-408, provided here for an illustrative purpose as one possible approach for the UE (300) to perform group affiliation, MB session announcement by the network, and MB session join.

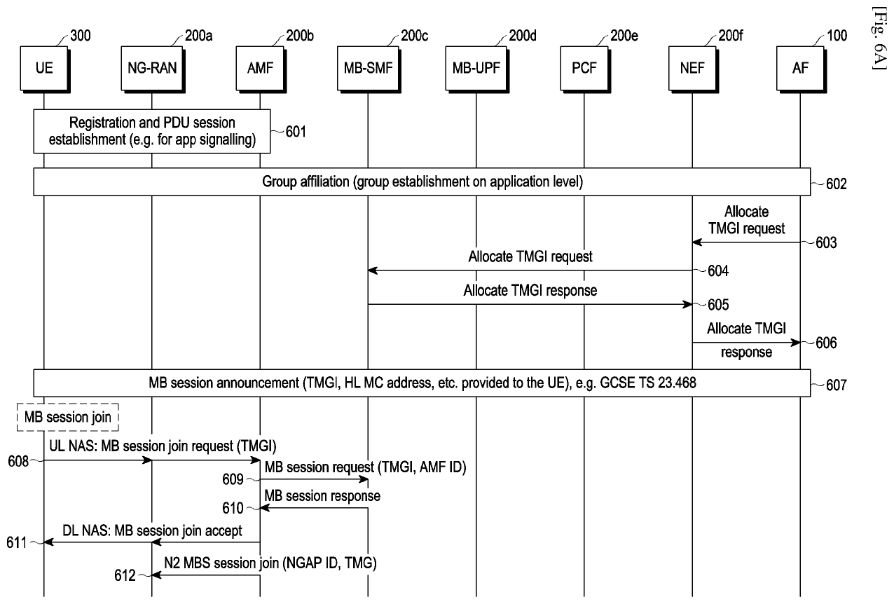

At step 409-410, if the AMF (200b) does not already have an MB Session context for the received TMGI (in step 408), then the AMF (200b) selects the MB-SMF (200c) for the TMGI by querying the NRF. An MB session request (TMGI, AMF ID) message is sent to the MB-SMF (200c) to announce the AMF's interest in the MB session. When the MB-SMF (200c) has returned an MB session response message, the AMF (200b) creates an MB session context in the ‘inactive’ state for the TMGI. The MB-SMF (200c) generates the session key (say, K_{MBS} as detailed in FIGS. 7A and 7B) for the TMGI (may be a combination of TMGI and MC address (for large networks or redundancy reasons, the NEF (200f)/MBSF might use multiple MB-SMFs (200c) (and MB-UPFs (200d))), selects a security mechanism(s) (encryption mechanism and/or Integrity protection mechanism or mechanism which performs both together) and generates an MBS key index for the TMGI. The MB-SMF (200c) may provide the MBS session security context data to the AMF (200b). The AMF (200b) stores the MBS session security context data for the TMGI, if received from the MB-SMF (200c) in the MB session context.

In an embodiment, the key management server (KMS) (not shown in FIGS. 4A and 4B) generates the session key (say, K_{MBS} as detailed in FIGS. 7A and 7B) for the TMGI, also selects the security mechanism(s) (encryption mechanism and/or integrity protection mechanism or mechanism which performs both together) and generates the MBS key index for the TMGI. The MB-SMF (200c) or the AMF (200b) fetch/obtains the key from the KMS (for example, using a key request/response exchange).

In an embodiment, the KMS can be collocated with the NEF (200f) or the AMF (200b), or MB-SMF (200c).

In an embodiment, the KMS is a standalone entity. In an embodiment, the KMS is discoverable by the other entities using the NRF.

If the AMF (200b) knows that the NG-RAN (200a) does not support the 5MBS, and in step 404 the MB-SMF (200c) has not received DisableIndividualDelivery from the AF (100), the AMF (200b) may decide to apply 5GC individual MBS traffic delivery when the MBS session is started later.

In an embodiment, the AMF (200b) can know if the NG-RAN (200a) supports the 5MBS based on the configuration.

If the AMF (200b) determines that the 5GC individual MBS traffic delivery should not be applied to the MBS session, and the NG-RAN (200a) does not support the 5MBS, then the AMF (200b) will reject a UE session join request. In this case, the N2 MB session join message in step 411 will be skipped.

At steps 411-412, the AMF (200b) stores the TMGI, MBS session security context data (if received from the SMF), and the NG RAN ID of an originating node of an N2 message in step 408 in the AMF MB session context. The AMF (200b) creates a DL NAS MB session join response message (which includes MBS session security context data) and piggybacks that on an N2 MB session join (NGAP ID, TMGI) message. The NG-RAN (200a) stores the TMGI in the UE context in the NG-RAN (200a).

In an embodiment, the AMF (200b) includes the MBS session security context data in the N2 MB session join message to the RAN/NG-RAN (200a) stores the MBS session security context data for the TMGI. The DL NAS MB session join response message (which includes MBS session security context data) is protected by the NAS security context.

In an embodiment, the UE (300) stores the received MBS session security context data for the TMGI.

In an embodiment, the key management server (KMS) generates the session key (say, KMBS as detailed in FIGS. 7A and 7B) for the TMGI, also selects the security mechanism(s) (encryption mechanism and/or Integrity protection mechanism or mechanism which performs both together) and generates the MBS key index for the TMGI. The AMF fetches/obtains the MBS session key from the KMS (for example, using a key request/response exchange that includes TMGI for key identification and retrieval).

In an embodiment, the KMS can be collocated with the NEF (200f) the AMF (200b), or the MB-SMF (200c). In an embodiment, the KMS is the standalone entity within the 5GC or outside of the 5GC. In an embodiment, the KMS is discoverable by the other entities using the NRF.

In an embodiment, the NG-RAN (200a) does only keep active MB session contexts, i.e. created during Session Start procedures.

In an embodiment, the primary purpose of the MB session context in the AMF (200b) is for the AMF (200b) to be able to manage the forwarding of session start messages to the NG-RAN nodes (200a) were members of the group are camping and to initiate group paging for CM-IDLE group members.

Step 413-426 represents MB session start. At 413, the AF (100) requests activation of the MB session by sending an activate MBS bearer request (TMGI, HL MC Address, and Service Requirement) message to the NEF (200f)/MBSF. The AF (100) has allocated a higher layer IP multicast address (HL MC Address). Service Requirement for the MB Session may be included. If multiple MBS QoS Flows are expected to be established, then the AF (100) needs to provide different packet filters and associated service requirements.

In an embodiment, a combined TMGI allocation and session start on an N33 API is assumed to use allocate TMGI request/response and MB session start messages on the N29 interface.

At 414, the NEF (200f)/MBSF checks if the input parameters e.g. HL MC address are valid. The NEF (200f)/MBSF sets the MB session context to active. The NEF (200f)/MBSF sends an MB session start (TMGI, service requirement) message to the MB-SMF (200c). At 415, the MB-SMF (200c) sends the TMGI for the MB session and the service requirement to the PCF (200e). The PCF (200e) returns a 5G QoS profile, which the MB-SMF (200c) uses as the 5G authorized QoS profile for the MB session. If multiple MBS service requirements are received, then the PCF (200e) will provide multiple 5G authorized QoS profiles. At 416, MB-SMF (200c) sets up the N6 resources for the MB session in the MB-UPF (200d) and the N3 resources for transport multicast tunneling using the LL MC address allocated for the TMGI.

Optionally, media reception in the MB-UPF (200d) is un-tunneled, in which case the MB-SMF (200c) also provides the HL MC Address so that the MB-UPF (200d) can send IGMP/MLD join and receive the (un-tunneled) IP Multicast Media stream. If N6 tunneling is used, the MB-UPF (200d) allocates N6 tunnel information (e.g. UDP port and IP address) and returns to the MB-SMF (200c). The MB-SMF (200c) stores the received info in the MB session context. If multiple MBS QoS flows are established, the MB-UPF (200d) maps the downlink MBS data to the MBS QoS flow based on the packet filters which could be HL MC address and ports, or unicast UDP tunnel info.

At 417, the MB-SMF (200c) sets the MB session context to active and sends the MB session start (TMGI, LL MC address and source host address, 5G authorized QoS profile) messages to all AMFs (200b) that has earlier joined the MB session. When the AMF (200b) receives the MB session start message, the AMF (200b) sets its MB session context to an active state. The AMF (200b) proceeds with step 418 and step 419 onwards in parallel.

In an embodiment, the LL MC address and the source host address of the MB-UPF (200d) is provided if multicast transport is configured to be used between the NG-RAN (200a) and the MB-UPF (200d). Otherwise, N3 point-to-point transport is assumed.

At 418, if the AMF (200b) has CM-IDLE UEs that have joined the MB Session (i.e. any CM-IDLE UE with the specific TMGI of an MB session is stored in the UE context of the AMF (200b)), the AMF (200b) performs the group paging including the group paging identity (TMGI) in the paging message in the registration areas of the CM-IDLE UEs. The NG-RAN (200a) triggers group paging. The AMF (200b) determines the group paging area by combing the paging areas of the individual UE (300) within the multicast group. The UEs (300) respond to the group paging e.g. by sending UL NAS MB session join request (TMGI) to the AMF (200b).

In an embodiment, How to handle group paging and how to efficiently listen for both unicast paging and group paging etc. are to be studied by RAN WGs. Steps 413-418, provided here for an illustrative purpose as one possible approach for the MB session start.

At 419, the AMF (200b) sends an MB session resource setup request (TMGI, LL MC, and source host address, 5G authorized QoS profile, MBS session security context data) message to all RAN nodes (e.g. NG-RAN (200a)) where CM connected UEs (e.g. UE (300)) that has joined the TMGI resides. The NG-RAN (200a) creates the MB session context (if it not already exists), sets it to the ‘active’ state, stores the TMGI, MBS session security context data, the QoS profile, and the list of AMF IDs in the MB session context. If the NG-RAN (200a) receives multiple MB session resource setup request messages for the same TMGI (e.g. from several AMFs (200b) the NG-RAN (200a) is connected to) (and even if the LL MCs are different in the case of multiple MB-UPFs (200d)), the NG-RAN (200a) stores each sender AMF ID in the MB session context, but only performs step 420a-420b once (instead continues at step 421). The LL MC address and the source host address are optional parameters and only provided by the AMF (200b) to the NG-RAN (200a) if N3 multicast transport is configured to be used in the 5GC.

At 420a-420b, if the NG-RAN (200a) prefers to use N3 multicast transport (and if LL MC Address is available in the NG-RAN (200a)), the NG-RAN (200a) joins the multicast group (i.e. LL MC Address). The NG-RAN (200a) establishes the PTM/PTP DL resources for the MB session, and if there are UEs (e.g. UE (300)) in CM-connected with RRC_INACTIVE state with the TMGI in their UE contexts, the NG-RAN (200a) performs a network triggered transition from a RRC_INACTIVE to RRC_CONNECTED procedure for those UEs (according to TS 38.300). For the TMGI's PTM MB sessions, the NG-RAN (200a) activates the security context and indicates the key index the NG-RAN (200a) is going to use to protect the communication over the Multicast Radio Bearer (MRB) to the UE (300).

In an embodiment, an indication of activation of the security for the MRB and the key index are provided over the signaling radio bearer (SRB) (e.g. RRC reconfiguration message) from the NG-RAN (200a) to the UEs (e.g. UE (300)).

In an embodiment, the UE (300a) and the NG-RAN (200a) derive the RAN-specific keys (K_{MBS-RAN}) from the MBS session key, as detailed in FIGS. 7A and 7B.

In an embodiment, the NG-RAN (200a) provides a current PDCP count (hyper-frame number (HFN) and the PDCP SN) or only the HFN to the UE (300), over the SRB (using a protected message), so that the UE (300) knows the HFN to decrypt or/and verify the integrity protection of the data over MRB.

In an embodiment, the NG-RAN (200a) and the UE (300) use reserved values (for example, all ‘0s’ or all ‘1s’), for the HFN and PDCP SN will not change the HFN when it wraps around. In an embodiment, UE (300) may also select HFN and/or SN value by itself e.g. according to the first received PDCP PDU SN received.

In an embodiment, the reserved value applies only to certain TMGIs (for example, Free broadcast/multicast sessions (free to watch sessions)).

In an embodiment, the NG-RAN (200a) and the UE (300) use only two reserved values (for example, only the least significant bit (LSB) of the HFN is either “0” or “1”), for the HFN and PDCP SN will toggle the LSB of the HFN when it wraps-around.

In an embodiment, the reserved value applies only to certain TMGIs (for example, Free broadcast/multicast sessions (free to watch sessions)).

In an embodiment, the NG-RAN (200a) and the UE (300) use only two reserved values (for example, only the Least significant bit (LSB) of the HFN is either “0” or “1” or 2 LSBs “00”, “01”, “10”, “11”), for the HFN and PDCP SN will toggle the LSB(s) of the HFN when it wraps-around.

In an embodiment, the reserved value applies only to certain TMGIs (for example, Free broadcast/multicast sessions (free to watch sessions)).

In an embodiment, the HFN is used as the shared secret for the MBS session (TMGI) by the NG-RAN (200a) and the UE (300). The NG-RAN (200a) provides the hyperframe number (HFN) to the UE (300), over the SRB (using a protected message).

At 421, the NG-RAN (200a) reports the successful establishment of the MB session resources (which may include multiple MBS QoS Flows) by sending an MB session resource setup response (TMGI, Tunnel Info) message(s) to the AMF (200b). The NG-RAN (200a) provides its tunnel info if the NG-RAN (200a) prefers to use N3 point-to-point transport (or if the LL MC Address is not available in the NG-RAN (200a)) between the NG-RAN (200a) and the MB-UPF (200d).

At 422, the AMF (200b) sends an MB session start acknowledgement (TMGI, Tunnel Info) to the MB-SMF (200c).

In an embodiment, the AMF (200b) may send an acknowledgement for each response it receives from the NG-RAN nodes (e.g. NG-RAN (200a)) (e.g. useful for small MCPTT areas). That is, steps 422 to 424 may be repeated multiple times (once for each involved the NG-RAN (200a)). The AMF (200b) may also use an upper limit for the number of acknowledgement sent and fall back to aggregated acknowledgement if the number of RAN acknowledgement goes beyond the limit (to reduce signaling load). That is, collect status from all or a number of downstream nodes (with time out) and then make an aggregated report. For example, an MCPTT server (not shown in FIGS. 4A and 4B) may want to start an MCPTT call (i.e. to transmit media) as soon as possible, e.g. already when a few members of a group can successfully receive the media. In such cases, it is reasonable to be able to send intermediate and multiple acknowledgements to the AF (100). If N3 point-to-point transport is to be used (i.e. Tunnel Info is present in the MB session start acknowledgement message from the AMF (200b)), the MB-SMF (200c) sends an N4 request to the MB-UPF (200d) to allocate the N3 point-to-point transport tunnel for a replicated MBS stream for the MB Session.

At 423-424, the MB-SMF (200c) sends the MB session start acknowledgement (TMGI) message to the NEF (200f)/MBSF. N6 Tunnel info is included in the response if not already provided to the AF (100). The NEF (200f)/MBSF sends an activate MBS bearer response including the N6 tunnel info to the AF (100).

At 425, the MB session is now active. The AF (100) starts transmitting a downlink (DL) media stream using the N6 tunnel info, or optionally un-tunneled i.e. as an IP multicast stream using the HL MC address. At 426, The NG-RAN (200a) transmits the received DL media stream using DL PTM or PTP resources. The NG-RAN (200a) uses the MBS session security context data of the TMGI to protect (encryption and/or integrity protection) the DL media stream. In an embodiment, the MBS session security context data is provided to the AF (100), using steps 423-424.

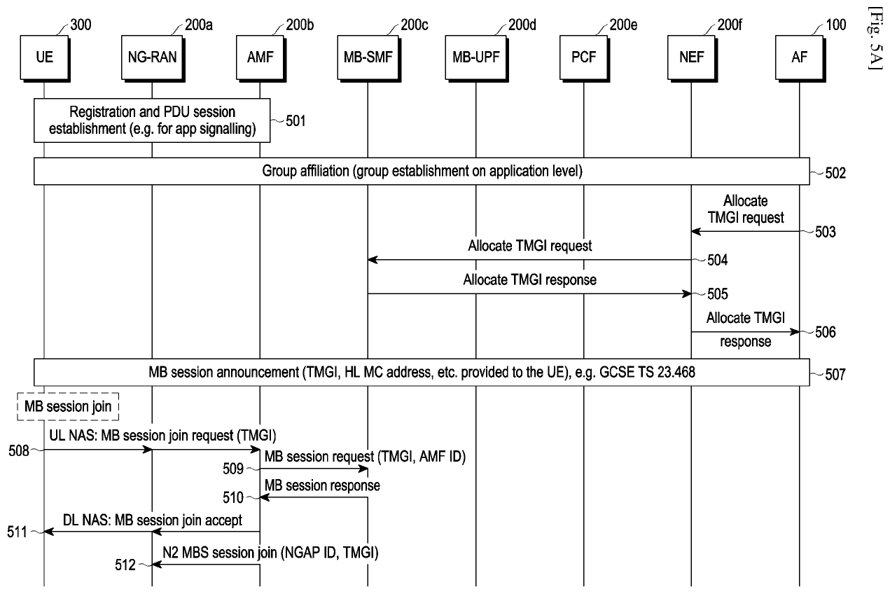

FIGS. 5A and 5B illustrate a scenario in which the MBS session security context is generated and distributed by the NG-RAN (200a) (for illustrative purposes gNB) to the UE (300), according to embodiments as disclosed herein.

At steps 501-502, the UE (300) registers, and the PDU session is established with the network entity (200) (e.g. NG-RAN (200a), AMF (200b)). The UE (300) and the AF (100) use the PDU session e.g. to signal and establish the group on the application-level (according to TS 23.468). If the PDU session is used for application-level signaling in steps 501 and 506, then it (PDU session) manages independently from the MB session. That is, the PDU session does for example not need to be maintained while the UE (300) is receiving multicast content.

At step 503, the AF (100) sends the allocate TMGI request message to the NEF (200f) to request allocation of the TMGI to identify the new group. Optionally, the TMGIs may be pre-allocated in the AF (100) and the 5GC (not shown in FIGS. 5A and 5B). When the pre-allocated TMGI is used, then the pre-allocated TMGI shall be included in the allocate TMGI request (TMGI) message. The combined TMGI allocation and session start on the N33 API interface is assumed to use allocate TMGI request/response and MB session start messages on the N29 interface. The AF (100) may include the new indication “DisablelndividualDelivery” to indicate if the 5GC individual MBS traffic delivery should not be applied for a specific MB Session e.g. due to application characteristics.

At step 504, the NEF (200f)/the MB-SMF (200c) selects based on local configuration the MB-SMF (200c) (if there are multiple) to handle the group and sends the allocate TMGI request message to the MB-SMF (200c). Optionally, the MBSF makes the TMGI allocation, stores it (TMGI allocation) in the MB session context, and includes the allocated TMGI in the message sending to the MB-SMF (200c). The MBSF may have a pre-configured TMGI range for each MB-SMF (200c). The TMGI range should also be configured/registered in the NRF to allow AMFs to discover which MB-SMF (200c) is controlling the MB session identified by the TMGI. Optionally, the TMGIs may be pre-allocated in the AF (100) and the 5GC e.g. based on the SLA. When the pre-allocated TMGI is used, then the pre-allocated TMGI shall be included in the allocate TMGI request (TMGI) message. The MB-SMF (200c) or optionally the MBSF shall after local checks (e.g. that it is allowed for pre-allocation and has not already been used) use the provided TMGI if present, and proceed as normal (i.e. store it in the MB session context, etc.). Further, the NEF (200f)/MBSF passes the indication DisableIndividualDelivery (if received) to the MB-SMF (200c).

At step 505, the MB-SMF (200c) allocates the TMGI (optionally pre-allocated TMGI may be used, as given in step 504), the LL MC address for the N3, and the N6 tunnel information and stores the information in the new MB session context set to ‘inactive’ state. The MB-SMF (200c) returns the TMGI and the N6 tunnel information to the NEF (200f)/MBSF. If the MB-SMF (200c) makes the TMGI allocation, it may e.g. allocate a TMGI from a pre-configured TMGI range.

In an embodiment, for large networks or redundancy reasons, the NEF (200f)/MBSF might use multiple MB-SMFs (200c) (and MB-UPFs (200d)).

In an embodiment, since the N3 LL MC address is used for the 5GS internal transport, it is considered sufficient to allocate the N3 LL MC address at session start i.e. when resources for the MB session are allocated in different nodes. A one-to-one relationship between N3 LL MC address and MB session is used.

At step 506, the NEF (200f)/MBSF establishes the new MB session context set to the ‘inactive’ state, stores received information and responds to the AF (100) by sending the allocate TMGI response (TMGI) message. At step 507, the MB session announcement (according to TS 23.468). The AF (100) informs the members in the group of various group info e.g. TMGI, HL MC Address. The HL MC address may be allocated by the AF (100) for the group/TMGI.

Steps 508-512 represents MB session join. At step 508, the UE (300) indicates its interest to join an MB session by sending the UL NAS MB session join request (TMGI) message. The NG-RAN (200a) forwards the NAS message to the AMF (200b). The AMF (200b) stores the TMGI in its UE context.

In an embodiment, the UE (300) always joins the MB session as such. For the MB session (i.e. the TMGI) that has several media streams, the UE (300) may choose to process and present all or the selected set of media streams.

In an embodiment this solution does for the moment not use the AF (100) based authorization of the UE (300) at session join (e.g. in step 409). Such authorization could potentially cause heavy signaling in the system without being motivated from the security point of view.

In an embodiment for a moment, it is unclear whether authorization of the UE (300) to join the MB session in the 5GC is needed. Authorization on the application layer is considered sufficient. If the requirement to have additional authorization in the 5GC becomes clear in the future, then a solution can be proposed, e.g. the AF (100) provisions the UDR (not shown in FIGS. 5A and 5B) with the necessary info and the UDR provides such info to the UDM (not shown in FIGS. 5A and 5B) as subscription data for the AMF (200b) to check. The alternative could be that the UE's authorization is performed at the 5MBS feature level, and this can be achieved by including a new authorization parameter for the 5MBS in the subscription data.

Step 503-508, provided here for an illustrative purpose as one possible approach for the UE (300) to perform the group affiliation, the MB session announcement by the network, and MB session join.

At step 509-510, if the AMF (200b) does not already have the MB session context for the received TMGI (in step 508), then the AMF (200b) selects the MB-SMF (200c) for the TMGI by querying an NRF. The MB session request (TMGI, AMF ID) message is sent to the MB-SMF (200c) to announce the AMF's interest in the MB session. When the MB-SMF (200c) has returned an MB session response message, the AMF (200b) creates the MB session context in the ‘inactive’ state for the TMGI.

If the AMF (200b) knows that the NG-RAN (200a) does not support the 5MBS, and in step 504 the MB-SMF (200c) has not received DisableIndividualDelivery from the AF (100), the AMF (200b) may decide to apply 5GC individual MBS traffic delivery when the MBS session is started later.

In an embodiment, the AMF (200b) can know if the NG-RAN (200a) supports the 5MBS based on the configuration. If the AMF (200b) determines that the 5GC individual MBS traffic delivery should not be applied to the MBS session, and the NG-RAN (200a) does not support the 5MBS, the AMF (200b) will reject the UE session join request. In this case, the N2 MB session join message in step 511 will be skipped.

At steps 511-512, the AMF (200b) stores the TMGI, MBS session security context data (if received from the SMF), and the NG RAN ID of an originating node of an N2 message in step 508 in the AMF MB session context. The AMF (200b) creates a DL NAS MB session join response message (and piggybacks that on an N2 MB session join (NGAP ID, TMGI) message. The NG-RAN (200a) stores the TMGI in the UE context in the NG-RAN (200a).

In an embodiment, the NG-RAN (200a) does only keep active MB Session Contexts, i.e. created during session start procedures.

In an embodiment, the primary purpose of the MB session context in the AMF (200b) is for the AMF (200b) to be able to manage the forwarding of session start messages to the NG-RAN nodes (200a) were members of the group are camping and to initiate Group paging for CM-IDLE group members.

Steps 503-512, provided here for an illustrative purpose as one possible approach for the UE (300) to perform the group affiliation, MB session announcement by the network, and MB session join

Steps 513-526 represents MB session start. At 513, the AF (100) requests activation of an MB Session by sending the activate MBS bearer request (TMGI, HL MC Address, and service requirement) message to the NEF (200f)/MBSF. The AF (100) has allocated the HL MC Address. The service requirement for the MB Session may be included. If multiple MBS QoS flows are expected to be established, then the AF (100) needs to provide different packet filters and associated service requirements.

In an embodiment, a combined TMGI allocation and session start on the N33 API is assumed to use allocate TMGI request/response and MB session start messages on the N29 interface.

At 514, the NEF (200f)/MBSF checks if the input parameters e.g. HL MC address are valid. The NEF (200f)/MBSF sets the MB session context to active. The NEF (200f)/MBSF sends the MB session start (TMGI, Service requirement) message to the MB-SMF (200c). At 515, the MB-SMF (200c) sends the TMGI for the MB session and the service requirement to the PCF (200e). The PCF (200e) returns the 5G QoS profile, which the MB-SMF (200c) uses as the 5G authorized QoS profile for the MB session. If multiple MBS service requirements are received, then the PCF (200e) will provide multiple 5G authorized QoS profiles. At 516, MB-SMF (200c) sets up the N6 resources for the MB session in the MB-UPF (200d) and the N3 resources for transport multicast tunneling using the LL MC address allocated for the TMGI.

Optionally, media reception in the MB-UPF (200d) is un-tunneled, in which case the MB-SMF (200c) also provides the HL MC Address so that the MB-UPF (200d) can send IGMP/MLD join and receive the (un-tunneled) IP Multicast Media stream. If N6 tunneling is used, the MB-UPF (200d) allocates the N6 tunnel information (e.g. UDP port and IP address) and returns to the MB-SMF (200c). The MB-SMF (200c) stores the received info in the MB session context. If multiple MBS QoS flows are established, the MB-UPF (200d) maps the downlink MBS data to the MBS QoS flow based on the packet filters which could be HL MC Address and ports, or unicast UDP tunnel info.

At 517, the MB-SMF (200c) sets the MB session context to active and sends the MB session start (TMGI, LL MC address and source host address, 5G authorized QoS profile) messages to all AMFs (200b) that has earlier joined the MB session. When the AMF (200b) receives the MB session start message, the AMF (200b) sets its MB session context to the active state. The AMF (200b) proceeds with step 518 and step 519 onwards in parallel.

In an embodiment, the LL MC address and source host address of the MB-UPF (200d) is provided if multicast transport is configured to be used between the NG-RAN (200a) and the MB-UPF (200d). Otherwise, the N3 point-to-point transport is assumed.

At 518, if the AMF (200b) has CM-IDLE UEs that have joined the MB session (i.e. any CM-IDLE UE with the specific TMGI of an MB session is stored in the UE context of the AMF (200b)), the AMF (200b) performs group paging including the TMGI in the paging message in the registration areas of the CM-IDLE UEs. The NG-RAN (200a) triggers group paging. The AMF (200b) determines the group paging area by combing the paging areas of the individual UE (300) within the multicast group. The UEs (300) respond to the group paging e.g. by sending UL NAS MB session join request (TMGI) to the AMF (200b).

In an embodiment, How to handle group paging and how to efficiently listen for both unicast paging and group paging etc. are to be studied by RAN WGs. Steps 513-518, provided here for an illustrative purpose as one possible approach for MB session start.

At 519, the AMF (200b) sends an MB session resource setup request (TMGI, LL MC, and source host address, 5G Authorized QoS Profile) message to all RAN nodes (e.g. NG-RAN (200a)) where CM connected UEs (e.g. UE (300)) that has joined the TMGI resides. The NG-RAN (200a) creates the MB session context (if it not already exists), sets it to the ‘active’ state, stores the TMGI, MBS session security context data, the QoS Profile, and a list of AMF IDs in the MB session context. If the NG-RAN (200a) receives multiple MB session resource setup request messages for the same TMGI (e.g. from several AMFs (200b) the NG-RAN (200a) is connected to) (and even if the LL MCs are different in the case of multiple MB-UPFs (200d)), the NG-RAN (200a) stores each sender AMF ID in the MB session context, but only performs step 520a-520b once (instead continues at step 521). The LL MC address and source host address are optional parameters and only provided by the AMF (200b) to the NG-RAN (200a) if N3 multicast transport is configured to be used in the 5GC.

In an embodiment, the NG-RAN (gNB) generates the session key (say, KMBS, as detailed in FIG. 7A-7B for the TMGI (may be a combination of TMGI and MC address), selects the security algorithm(s) (encryption algorithm and/or Integrity protection algorithm or an algorithm that performs both together) and generates the MBS key index for the TMGI.

In an embodiment, the KMS generates the session key (say, KMBS as detailed in FIG. 7A-7B) for the TMGI, also selects the security algorithm(s) (encryption algorithm and/or Integrity protection algorithm or algorithm which performs both together) and generates the MBS key index for the TMGI. The NG-RAN (200a) fetches/obtains the MBS session key from the KMS (for example, using the key request/response exchange which includes TMGI for key identification and retrieval).

At 520a-520b, if the NG-RAN (200a) prefers to use N3 multicast transport (and if LL MC Address is available in the NG-RAN (200a)), the NG-RAN (200a) joins the multicast group (i.e. LL MC Address). The NG-RAN (200a) establishes PTM or PTP DL resources for the MB Session, and if there are UEs (e.g. UE (300)) in CM-connected with RRC_INACTIVE state with the TMGI in their UE contexts, the NG-RAN (200a) performs a Network triggered the transition from RRC_INACTIVE to RRC_CONNECTED procedure for those UEs (according to TS 38.300). The NG-RAN (200a) provides the MBS session security context data to the UE (300) over SRB.

In an embodiment, the NG-RAN (200a) provides the MBS session security context data in protect RRC message to the UE (300). The UE (300) stores the MBS session security context data for the TMGI, in the MB Session Context

In an embodiment, the NG-RAN (200a) provides a current PDCP count (hyper-frame number (HFN) and the PDCP SN) or only the HFN to the UE (300), over the SRB (using the protected message), so that the UE (300) knows the HFN to decrypt or/and verify the integrity protection of the data over MRB.

In an embodiment, the NG-RAN (200a) and the UE (300) use reserved values (for example, all ‘0s’ or all ‘1s’), for the HFN and PDCP SN will not change the HFN when it wraps around.

In an embodiment, the reserved value applies only to certain TMGIs (for example, Free broadcast/multicast sessions (free to watch sessions)).

In an embodiment, the NG-RAN (200a) and the UE (300) use only two reserved values (for example, only the Least significant bit (LSB) of the HFN is either “0” or “1” or 2 LSBs “00”, “01”, “10”, “11”), for the HFN and PDCP SN will toggle the LSB(s) of the HFN when it wraps-around.

In an embodiment, the reserved value applies only to certain TMGIs (for example, Free broadcast/multicast sessions (free to watch sessions)).

In an embodiment, the HFN is used as the shared secret for the MBS session (TMGI) by the NG-RAN (200a) and the UE (300). The NG-RAN (200a) provides the hyperframe number (HFN) to the UE (300), over the SRB (using the protected message).

At 521, the NG-RAN (200a) reports the successful establishment of the MB session resources (which may include multiple MBS QoS flows) by sending an MB session resource setup response (TMGI, Tunnel Info) message(s) to the AMF (200b). The NG-RAN (200a) provides its Tunnel Info if the NG-RAN (200a) prefers to use N3 point-to-point transport (or if the LL MC Address is not available in the NG-RAN (200a)) between the NG-RAN (200a) and the MB-UPF (200d).

At 522, the AMF (200b) sends the MB session start acknowledgement (TMGI, Tunnel Info) to the MB-SMF (200c).

In an embodiment, the AMF (200b) may send the acknowledgement for each response it receives from the NG-RAN nodes (e.g. NG-RAN (200a)) (e.g. useful for small MCPTT areas). That is, steps 522 to 524 may be repeated multiple times (once for each involved the NG-RAN (200a)). The AMF (200b) may also use an upper limit for the number of acknowledgement sent and fall back to aggregated acknowledgement if the number of RAN acknowledgement goes beyond the limit (to reduce signaling load). That is, collect status from all or a number of downstream nodes (with time out) and then make an aggregated report. For example, the MCPTT server (not shown in FIGS. 5A and 5B) may want to start an MCPTT call (i.e. to transmit media) as soon as possible, e.g. already when the few members of a group can successfully receive the media. In such cases, it is reasonable to be able to send intermediate and multiple acknowledgements to the AF (100). If N3 point-to-point transport is to be used (i.e. Tunnel Info is present in the MB session start acknowledgement message from the AMF (200b)), the MB-SMF (200c) sends an N4 request to the MB-UPF (200d) to allocate the N3 point-to-point transport tunnel for a replicated MBS stream for the MB session.

At 523-524, the MB-SMF (200c) sends the MB session start acknowledgement (TMGI) message to the NEF (200f)/MBSF. The N6 Tunnel info is included in the response if not already provided to the AF (100). The NEF (200f)/MBSF sends the activate MBS bearer response including the N6 tunnel info to the AF (100).

At 525, the MB session is now active. The AF (100) starts transmitting the DL media stream using the N6 tunnel info, or optionally un-tunneled i.e. as the IP multicast stream using the HL MC address. At 526, The NG-RAN (200a) transmits the received DL media stream using DL PTM or PTP resources. The NG-RAN (200a) uses the MBS session security context data of the TMGI to protect (encryption and/or integrity protection) the DL media stream. In an embodiment, the MBS session security context data is provided to the AF (100), using steps 522-524.

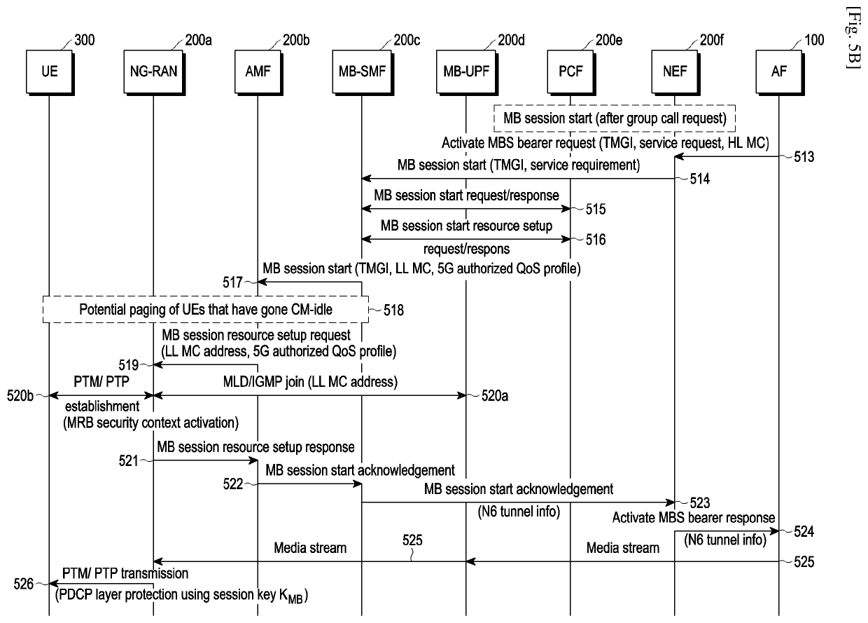

FIGS. 6A and 6B illustrate a scenario in which the MBS session security context is generated and distributed by an application function (for illustrative purposes the AF (100)) to the UE (300), according to embodiments as disclosed herein.

At steps 601-602, the UE (300) registers, and the PDU session is established with the network entity (200) (e.g. NG-RAN (200a), AMF (200b)). The UE (300) and the AF (100) use the PDU Session e.g. to signal and establish the group on the application-level (according to TS 23.468). If the PDU session is used for application-level signaling in steps 601 and 606, then the PDU session manages independently from the MB session. That is, the PDU session does for example not need to be maintained while the UE (300) is receiving multicast content.

At step 603, the AF (100) sends the allocate TMGI request message to the NEF (200f) to request allocation of the TMGI to identify the new group. Optionally, the TMGIs may be pre-allocated in the AF (100) and the 5GC (not shown in FIGS. 5A and 5B). When the pre-allocated TMGI is used, the pre-allocated TMGI shall be included in the allocate TMGI request (TMGI) message. The combined TMGI allocation and session start on the N33 API interface is assumed to use allocate TMGI request/response and MB session start messages on the N29 interface. The AF (100) may include the new indication “DisableIndividualDelivery” to indicate if the 5GC individual MBS traffic delivery should not be applied for a specific MB session e.g. due to application characteristics.

At step 604, the NEF (200f)/the MB-SMF (200c) selects based on local configuration the MB-SMF (200c) (if there are multiple) to handle the group and sends the allocate TMGI request message to the MB-SMF (200c). Optionally, the MBSF makes the TMGI allocation, stores it (TMGI allocation) in the MB session context, and includes the allocated TMGI in the message sending to the MB-SMF (200c). The MBSF may have a pre-configured TMGI range for each MB-SMF (200c). The TMGI range should also be configured/registered in the NRF to allow AMFs to discover which MB-SMF (200c) is controlling the MB session identified by the TMGI. Optionally TMGIs may be pre-allocated in the AF (100) and the 5GC e.g. based on the SLA. When the pre-allocated TMGI is used, the pre-allocated TMGI shall be included in the allocate TMGI request (TMGI) message. The MB-SMF (200c) or optionally the MBSF shall after local checks (e.g. that it is allowed for pre-allocation and has not already been used) use the provided TMGI if present, and proceed as normal (i.e. store it in the MB session context, etc.). The NEF (200f)/MBSF passes the indication DisableIndividualDelivery (if received) to the MB-SMF (200c).

At step 605, the MB-SMF (200c) allocates the TMGI (optionally pre-allocated TMGI may be used, are given in step 604), the LL MC address for the N3, and the N6 tunnel information and stores the information in the new MB session context set to ‘inactive’ state. The MB-SMF (200c) returns the TMGI and the N6 tunnel information to the NEF (200f)/MBSF. If the MB-SMF (200c) makes the TMGI allocation, it may e.g. allocate the TMGI from a pre-configured TMGI range.

In an embodiment, for large networks or redundancy reasons, the NEF (200f)/MBSF might use multiple MB-SMFs (200c) (and MB-UPFs (200d)).

In an embodiment, since the N3 LL MC address is used for the 5GS internal transport, it is considered sufficient to allocate the N3 LL MC address at session start i.e. when resources for the MB session are allocated in different nodes. A one-to-one relationship between N3 LL MC Address and MB session is used.

At step 606, the NEF (200f)/MBSF establishes the new MB session context set to ‘inactive’ state, stores received information and responds to the AF (100) by sending the allocate TMGI Response (TMGI) message. At step 607, the MB session announcement (according to TS 23.468). The AF (100) informs the members in the group of various group info e.g. TMGI, HL MC Address. The HL MC address may be allocated by the AF (100) for the group/TMGI.

Steps 608-612 represents MB session join. At step 608, the UE (300) indicates its interest to join an MB session by sending the UL NAS MB session join request (TMGI) message. The NG-RAN (200a) forwards the NAS message to the AMF (200b). The AMF (200b) stores the TMGI in its UE context.

In an embodiment, the UE (300) always joins the MB session as such. For the MB session (i.e. the TMGI) that has several media streams, the UE (300) may choose to process and present all or the selected set of media streams.

Note: The AF (100) provisions the UDR with the necessary info and the UDR provides such info to the UDM as subscription data for the AMF (200b) to check. The alternative could be that the UE's authorization is performed at the 5MBS feature level, and this can be achieved by including a new authorization parameter for the 5MBS in the subscription data.

Step 603-608, provided here for an illustrative purpose as one possible approach for the UE (300) to perform the group affiliation, the MB session announcement by the network, and MB session join.

At step 609-610, if the AMF (200b) does not already have the MB session context for the received TMGI (in step 508), the AMF (200b) selects the MB-SMF (200c) for the TMGI by querying an NRF. The MB session request (TMGI, AMF ID) message is sent to the MB-SMF (200c) to announce the AMF's interest in the MB session. When the MB-SMF (200c) has returned the MB session response message, the AMF (200b) creates the MB session context in an ‘inactive’ state for the TMGI.

If the AMF (200b) knows that the NG-RAN (200a) does not support the 5MBS, and in step 604 the MB-SMF (200c) has not received DisableIndividualDelivery from the AF (100), the AMF (200b) may decide to apply 5GC individual MBS traffic delivery when the MBS session is started later.

In an embodiment, the AMF (200b) can know if the NG-RAN (200a) supports the 5MBS based on the configuration. If the AMF (200b) determines that the 5GC individual MBS traffic delivery should not be applied to the MBS session, and the NG-RAN (200a) does not support the 5MBS, the AMF (200b) will reject the UE session join request. In this case, the N2 MB session join message in step 611 will be skipped.

At steps 611-612, the AMF (200b) stores the TMGI, MBS session security context data (if received from the SMF), and the NG RAN ID of an originating node of an N2 message in step 508 in the AMF MB session context. The AMF (200b) creates the DL NAS MB session join response message (and piggybacks that on an N2 MB session join (NGAP ID, TMGI) message. The NG-RAN (200a) stores the TMGI in the UE context in the NG-RAN (200a).

In an embodiment, the NG-RAN (200a) does only keep active MB Session Contexts, i.e. created during session start procedures.

In an embodiment, the primary purpose of the MB session context in the AMF (200b) is for the AMF (200b) to be able to manage the forwarding of session start messages to the NG-RAN nodes (200a) were members of the group are camping and to initiate Group paging for CM-IDLE group members.

Steps 603-612, provided here for an illustrative purpose as one possible approach for the UE (300) to perform the group affiliation, MB session announcement by the network, and MB session join

Steps 613-626 represents MB session start. At 613, the AF (100) requests activation of an MB Session by sending the activate MBS bearer request (TMGI, HL MC address, and service requirement, MBS session security context data) message to the NEF (200f)/MBSF. The AF (100) has allocated the HL MC address. The service requirement for the MB Session may be included. If multiple MBS QoS flows are expected to be established, then the AF (100) needs to provide different packet filters and associated service requirements.

The AF (100) generates the session key (say, K_{MBS}) for the TMGI (may be a combination of TMGI and MC address), selects the security algorithm(s) (encryption algorithm and/or Integrity protection algorithm or an algorithm that performs both together) and generates the MBS Key index for the TMGI.

In an embodiment, the KMS generates the session key (say, K_{MBS} as detailed in FIGS. 7A and 7B) for the TMGI, also selects the security algorithm(s) (encryption algorithm and/or Integrity protection algorithm or algorithm which performs both together) and generates the MBS key index for the TMGI. The AF (100) fetches/obtains the MBS session key from the KMS (for example, using the key request/response exchange which includes TMGI for key identification and retrieval).

In an embodiment, a combined TMGI allocation and session start on the N33 API is assumed to use allocate TMGI request/response and MB session start messages on the N29 interface.

At 614, the NEF (200f)/MBSF checks if the input parameters e.g. HL MC address are valid. The NEF (200f)/MBSF sets the MB session context to active. The NEF (200f)/MBSF sends the MB session start (TMGI, service requirement, MBS session security context data)) message to the MB-SMF (200c). At 615, the MB-SMF (200c) sends the TMGI for the MB session and the service requirement to the PCF (200e). The PCF (200e) returns the 5G QoS profile, which the MB-SMF (200c) uses as the 5G authorized QoS profile for the MB session. If multiple MBS service requirements are received, then the PCF (200e) will provide multiple 5G authorized QoS profiles. At 616, MB-SMF (200c) sets up the N6 resources for the MB session in the MB-UPF (200d) and the N3 resources for transport multicast tunneling using the LL MC address allocated for the TMGI.

Optionally, media reception in the MB-UPF (200d) is un-tunneled, in which case the MB-SMF (200c) also provides the HL MC Address so that the MB-UPF (200d) can send IGMP/MLD join and receive the (un-tunneled) IP Multicast Media stream. If N6 tunneling is used, the MB-UPF (200d) allocates the N6 tunnel information (e.g. UDP port and IP address) and returns to the MB-SMF (200c). The MB-SMF (200c) stores the received info in the MB session context. If multiple MBS QoS flows are established, the MB-UPF (200d) maps the downlink MBS data to the MBS QoS flow based on the packet filters which could be HL MC Address and ports, or unicast UDP tunnel info.

At 617, the MB-SMF (200c) sets the MB session context to active and sends the MB session start (TMGI, LL MC Address, and source host address, 5G authorized QoS profile, MBS session security context data) messages to all AMFs (200b) that has earlier joined the MB session. When the AMF (200b) receives the MB session start message, the AMF (200b) sets its MB session context to the active state. The AMF (200b) proceeds with step 618 and step 619 onwards in parallel.

In an embodiment, the LL MC Address and source host address of the MB-UPF (200d) is provided if multicast transport is configured to be used between the NG-RAN (200a) and the MB-UPF (200d). Otherwise, the N3 point-to-point transport is assumed.

At 618, if the AMF (200b) has CM-IDLE UEs that have joined the MB Session (i.e. any CM-IDLE UE with the specific TMGI of an MB session is stored in the UE context of the AMF (200b)), the AMF (200b) performs group paging including the TMGI in the paging message in the registration areas of the CM-IDLE UEs. The NG-RAN (200a) triggers group paging. The AMF (200b) determines the group paging area by combing the paging areas of the individual UE (300) within the multicast group. The UEs (300) respond to the group paging e.g. by sending UL NAS MB session join request (TMGI) to the AMF (200b).

In an embodiment, How to handle group paging and how to efficiently listen for both unicast paging and group paging etc. are to be studied by RAN WGs. Steps 613-618, provided here for an illustrative purpose as one possible approach for MB session start.

At 619, The AMF (200b) sends an MB session resource setup request (TMGI, LL MC, and source host address, 5G Authorized QoS Profile, MBS session security context data) message to all RAN nodes (e.g. NG-RAN (200a)) where CM connected UEs (e.g. UE (300)) that has joined the TMGI resides. The NG-RAN (200a) creates the MB session context (if it not already exists), sets it to the ‘active’ state, stores the TMGI, MBS session security context data, the QoS Profile, and a list of AMF IDs in the MB session context. If the NG-RAN (200a) receives multiple MB session resource setup request messages for the same TMGI (e.g. from several AMFs (200b) the NG-RAN (200a) is connected to) (and even if the LL MCs are different in the case of multiple MB-UPFs (200d)), the NG-RAN (200a) stores each sender AMF ID in the MB session context, but only performs step 620a-620b once (instead continues at step 621). The LL MC Address and source host address are optional parameters and only provided by the AMF (200b) to the NG-RAN (200a) if N3 multicast transport is configured to be used in the 5GC.

At 620a-620b, If the NG-RAN (200a) prefers to use N3 multicast transport (and if LL MC Address is available in the NG-RAN (200a)), the NG-RAN (200a) joins the multicast group (i.e. LL MC Address). The NG-RAN (200a) establishes PTM or PTP DL resources for the MB Session, and if there are UEs (e.g. UE (300)) in CM-connected with RRC_INACTIVE state with the TMGI in their UE contexts, the NG-RAN (200a) performs a Network triggered the transition from RRC_INACTIVE to RRC_CONNECTED procedure for those UEs (according to TS 38.300). The NG-RAN (200a) provides the MBS session security context data to the UE (300) over SRB.

In an embodiment, the NG-RAN (200a) provides the MBS session security context data in protect RRC message to the UE (300). The UE (300) stores the MBS session security context data for the TMGI, in the MB Session Context

In an embodiment, the NG-RAN (200a) provides the current PDCP count (hyper-frame number (HFN) and the PDCP SN) or only the HFN to the UE (300), over the SRB (using the protected message), so that the UE (300) knows the HFN to decrypt or/and verify the integrity protection of the data over MRB.

In an embodiment, the NG-RAN (200a), provides a freshness parameter (say, a random number) along with the MBS session security context data to the UE. The UE (300) and the NG-RAN (200a) derives further keys using the session key, random number, and other possible parameters (using one of the alternative detailed in FIGS. 7A and 7B). The generated keys using the session key is used to protect the traffic over the MRB.

At 621, the NG-RAN (200a) reports the successful establishment of the MB session resources (which may include multiple MBS QoS Flows) by sending an MB session resource setup response (TMGI, Tunnel Info) message(s) to the AMF (200b). The NG-RAN (200a) provides its Tunnel Info if the NG-RAN (200a) prefers to use N3 point-to-point transport (or if the LL MC Address is not available in the NG-RAN (200a)) between the NG-RAN (200a) and the MB-UPF (200d).

At 622, the AMF (200b) sends the MB session start acknowledgement (TMGI, Tunnel Info) to the MB-SMF (200c).

In an embodiment, the AMF (200b) may send the acknowledgement for each response it receives from the NG-RAN nodes (e.g. NG-RAN (200a)) (e.g. useful for small MCPTT areas). That is, steps 622 to 624 may be repeated multiple times (once for each involved the NG-RAN (200a)). The AMF (200b) may also use an upper limit for the number of acknowledgement sent and fall back to aggregated acknowledgement if the number of RAN acknowledgement goes beyond the limit (to reduce signaling load). That is, collect status from all or a number of downstream nodes (with time out) and then make an aggregated report. For example, the MCPTT server (not shown in FIGS. 6A and 6B) may want to start an MCPTT call (i.e. to transmit media) as soon as possible, e.g. already when the few members of a group can successfully receive the media. In such cases, it is reasonable to be able to send intermediate and multiple acknowledgements to the AF (100). If N3 point-to-point transport is to be used (i.e. Tunnel Info is present in the MB session start acknowledgement message from the AMF (200b)), the MB-SMF (200c) sends an N4 request to the MB-UPF (200d) to allocate the N3 point-to-point transport tunnel for a replicated MBS stream for the MB Session.

At 623-624, the MB-SMF (200c) sends the MB session start acknowledgement (TMGI) message to the NEF (200f)/MBSF. The N6 Tunnel info is included in the response if not already provided to the AF (100). The NEF (200f)/MBSF sends the activate MBS bearer response including the N6 tunnel info to the AF (100).

At 625, the MB session is now active. The AF (100) starts transmitting the DL media stream using the N6 tunnel info, or optionally un-tunneled i.e. as the IP multicast stream using the HL MC address. At 626, The NG-RAN (200a) transmits the received DL media stream using DL PTM or PTP resources. The NG-RAN (200a) uses the MBS session security context data of the TMGI to protect (encryption and/or integrity protection) the DL media stream. In an embodiment, the MBS session security context data is provided to the AF (100), using steps 622-624.

Key derivation: In an embodiment, MBS bearer can comprise of MRB (PTM) or DRB (PTP) or a combination of MRB (PTM) and DRB (PTP). The MBS bearer in either of the forms mentioned can carry broadcast and/or multicast control or user data traffic. Besides, there can be a unicast bearer which can also be used by the network to carry DRB and can be configured by the network to carry the multicast user data traffic. Therefore, a PTM path is associated/protected with the MBS key (K_{MBS}), and a PTP path is associated/protected with a UP key (K_{UP}).

In an embodiment, a PTP path is used to carry MRB and therefore, needs to be associated with the MBS key (K_{MBS}).

In an embodiment, the MBS bearer can be configured/reconfigured dynamically with setup/modification/release of PTM and/or PTP separately at different times or together at the same time. Therefore, the associated key(s) are dynamically provided/modified/released. The associated key(s) may also relate to integrity and/or encryption and these two security contexts can be separately or together configured/modified/released for the PTM and/or PTP paths.

FIG. 7A illustrates an MBS security key hierarchy generation for the Point-To-Multipoint (PTM) scenario, according to embodiments as disclosed herein.

The K_{MBS} (701) is an anchor/master/primary key, for a particular TMGI, generated by one of the: the 5GC (SMF (e.g. MB-SMF (200c))), 5GC (AMF (e.g. AMF (200b))), the Application Function (AF) (e.g. AF (100)), 5GC (K_{MBS}), KMS (outside of the operator's domain). The K_{MBS} (701) is provided to the UE (300) and may be to the NG-RAN (200a), if generated by the 5GC network functions or by the application function (AF (100)). The network entity (200)/function generates and distributes the K_{MBS} (for example, random key generated from a Key derivation function or a random number generation function or pseudorandom function (PRF)).

The K_{MBS-RAN} (702) is a key generated by the UE (300) and the NG-RAN (200a) from the MBS key is the K_{MBS} (701) or the KgNB. The K_{MBS-RAN} (702) is used to derive further keys that are used between the UE (300) and the NG-RAN (200a) to protect MBS. In an embodiment, the K_{MBS-RAN} (702) is a key generated by the NG-RAN (200a). The K_{MBS-RAN} (702) is provided by the NG-RAN (200a) to the UE (300).

The K_{MRBint} (or K_{MBSint}) (703) is a key generated by the UE (300) and the NG-RAN (200a) from the MBS RAN specific key the K_{MBS-RAN} (702), which is used for the protection of MBS traffic with a particular integrity mechanism.

The K_{MRBenc} (or K_{MBSenc}) (704) is a key generated by the UE (300) and the NG-RAN (200a) from MBS RAN specific key the K_{MBS-RAN} (702), which is used for the protection of the MBS traffic with a particular encryption mechanism.

The K_{MRB}sec (or K_{MBSsec}) is a key generated by the UE (300) and the NG-RAN (200a) from MBS RAN specific key the K_{MBS-RAN} (702), which is used for the protection of the MBS traffic with a particular security mechanism (which does both encryption and integrity protection).

An illustrative example, of deriving MBS keys: Key generation is performed using a Key Derivation Function (KDF) specified in Annex B.2.0 of TS 33.220. When deriving the key, the input parameters are used to form the input S to the KDF.

In an embodiment, the NG-RAN derives a cell-specific key from the session key (K_{MBS}) is derived by the below equation 1.

K_{MBS-RAN}=KDF{K_{MBS},<other possible parameters>} (1)

other possible parameters are one of the TMGI, the Count_{MBS}, the PCI, the DL frequency, and the RAND.

Further from the NG-RAN specific key, encryption and/or integrity protection key(s) are derived by the below equations 2-5,

K_{MRB-enc}=KDF{K_{MBS-RAN},<other possible parameters>} (2)

K_{MRB-int}=KDF{K_{MBS-RAN},<other possible parameters>} (3)

K_{MRB-int}∥K_{MRB-enc}=KDF{K_{MBS-RAN},<other possible parameters>} (4)

K_{MRB-sec}=KDF{K_{MBS-RAN},<other possible parameters>} (5)

where, other possible parameters are one of the TMGI, the Count_{MBS}, the PCI, the DL frequency (Absolute Radio Frequency Channel Number (ARFCN)-DL), the RAND, the distinguisher value differentiating the mechanism, the identifier value, the Key index, and the MC address.

In another embodiment, further from the NG-RAN specific key, encryption and/or integrity protection key(s) are derived from the K_{MBS} are derived by the below equations 6-9.

K_{MRB-enc}=KDF{K_{MBS},<other possible parameters>} (6)

K_{MRB-int}=KDF{K_{MBS},<other possible parameters>} (7)

K_{MRB-int}∥K_{MRB-enc}=KDF{K_{MBS},<other possible parameters>} (8)

K_{MRB-sec}=KDF{K_{MBS},<other possible parameters>} (9)

where, other possible parameters are one of the TMGI, the Count_{MBS}, the PCI, the DL frequency (ARFCN-DL), the RAND, the distinguisher value, the identifier value of the mechanism, the Key index, and the MC address.

Details of the input parameters to derive the MBS keys are given below:
a. TMGI: The TMGI is included in the key generation to bind the key to a specific TMGI. In other words, the TMGI is included in the key generator to generate a unique key for the TMGI.
b. Count_{MBS}: The Count_{MBS} is used as a freshness parameter in refreshing the key (in other words, not to generate the same key every time), as to mitigate the replay attack. The NG-RAN (200a) associates a counter, called a Count_{MBS}, with the MBS security context. The Count_{MBS} is used as freshness input into key derivations. The NG-RAN (200a) sends the value of the Count_{MBS} to the UE (300) over the RRC signaling path when it is required to generate a new MBS key. The NG-RAN (200a) maintains the value of the counter for a duration of the current MBS security context between the UE (300) and the NG-RAN (200a). The UE (300) and the NG-RAN (200a) associate a 16-bit counter, Counter_{ECS}, with the MBS key. The NG-RAN (200a) initializes the Count_{MBS} to 0x00 0x01 when the K_{MBS-RAN} (702) is derived. The UE (300) and the NG-RAN (200a) maintain the Count_{MBS} for a lifetime of the K_{MBS-RAN} (702). The Count_{MBS} is incremented by the NG-RAN (200a) for every new computation of the K_{MBS-RAN} (702). The NG-RAN (200a) sends the value of the Count_{MBS} (used to generate the K_{ECS-PSK}) to the UE (300). The UE (300) accepts the Count_{MBS} value that is greater than the stored Count_{MBS} value.
c. PCI and/or ARFCN-DL: The PCI and/or ARFCN-DL is included in the key generation to bind the key to a specific RAN Cell. In other words, PCI and/or ARFCN-DL are included in the key generation to generate a unique key for the cell, so that key stream repetition across cells does not happen.
d. RAND: The RAND is used to is used as a freshness parameter in refreshing the key (in other words, not to generate the same key every time), as to generate the unique key for every key generation and to provide it to only authorized UEs. The RAND is used to prevent the UE (300) deriving the keys, which are not authorized for the current session, but obtained the MBS security context for the previous sessions.
e. Distinguisher value and/or identifier value: The distinguisher value and/or identifier value is to derive unique keys for particular traffic and particular mechanism.
f. MBS key index: The MBS key index is included in the key generation to bind the generated key to a specific MBS security context. In other words, the key index is included in the key generation to generate the unique key for the MBS security context, so that key derivation is tagged or to ensure the right security context is derived.
g. IP address: The IP address is included in the key generation to bind the generated key to a specific multicast IP address. In other words, IP address is included in the key generation to generate the unique key for the MBS security context, so that key derivation is tagged or to ensure the key is used for a particular multicast session.

FIG. 7B illustrates an MBS security key derivation scheme (705) for the Point-To-Point (PTP) scenario, according to embodiments as disclosed herein.

The keys for PTP (MBS over DRB) protection are derived from the KgNB. Encryption and/or integrity protection key(s) are derived from the K_{gNB} (702) derived by the below equations 10-13.

K_{MRB-enc}=KDF{K_{gNB},<other possible parameters>} (10)

K_{MRB-int}=KDF{K_{gNB},<other possible parameters>} (11)

K_{MRB-int}∥K_{MRB-enc}=KDF{K_{gNB},<other possible parameters>} (12)

K_{MRB-sec}=KDF{K_{gNB},<other possible parameters>} (13)

where, other possible parameters are one of the TMGI, the Count_{MBS}, the PCI, the DL Frequency (ARFCN-DL), the RAND, the distinguisher value, the identifier value, the Key index, and the MC address. Illustrated distinguisher values are given in Table-1.

TABLE 1

| Distinguisher | Value |
|---|---|
| N-NAS-enc-alg | 0x01 |
| N-NAS-int-alg | 0x02 |
| N-RRC-enc-alg | 0x03 |
| N-RRC-int-alg | 0x04 |
| N-UP-enc-alg | 0x05 |
| N-UP-int-alg | 0x06 |
| N-MBS-enc-alg | 0x07 |
| N-MBS-int-alg | 0x08 |

In an embodiment, the keys for PTP (MBS over DRB) protection are derived from K_{MBS} or K_{MBS-RAN}. Encryption and/or integrity protection key(s) are derived from the K_{MBS} (701) or the K_{MBS-RAN} (702) derived by the below equations 14-17.

K_{MRB-enc}=KDF{K_{MBS} or K_{MBS-RAN},<other possible parameters>} (14)

K_{MRB-int}=KDF{K_{MBS} or K_{MBS-RAN},<other possible parameters>} (15)

K_{MRB-int}∥K_{MRB-enc}=K_{MBS} or K_{MBS-RAN}{K_{gNB},<other possible parameters>} (16)

K_{MRB-sec}=KDF{K_{MBS} or K_{MBS-RAN},<other possible parameters>} (17)

where, other possible parameters are one of the TMGI, the Count_{MBS}, the PCI, the DL Frequency (ARFCN-DL), the AND, the distinguisher value, the identifier value, the key index, and the MC address.

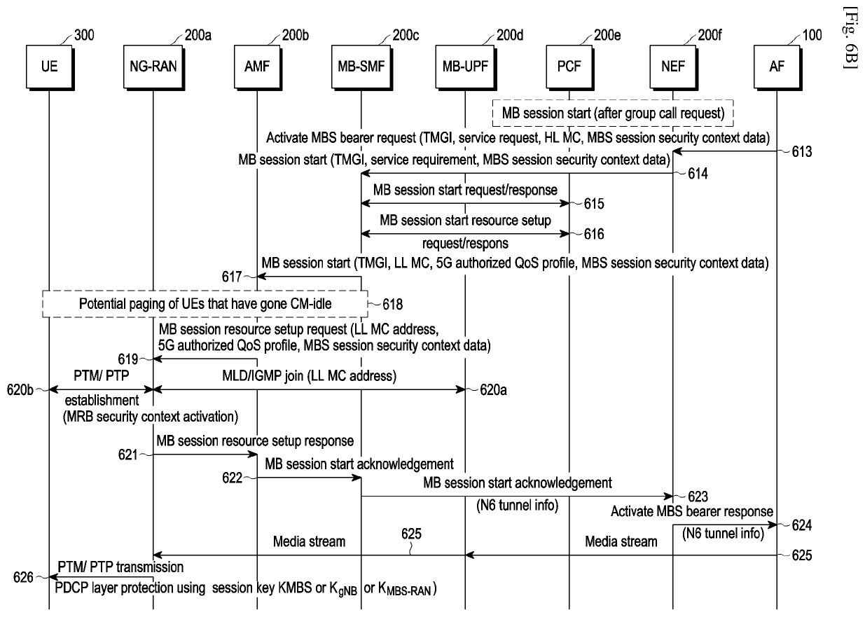

FIG. 8 illustrates a difference between a legacy PDCP entity (800a) and a new PDCP entity (800b), according to embodiments as disclosed herein.

In one embodiment, the new PDCP entity (800b) is proposed, which caters a MBS-split bearer (i.e. composed of one or more MRB/PTM and one or more DRB/PTP together). There may be one or more instances of functions corresponding to one or more deciphering, integrity protection and header decompression for one or more MRB and one or more DRB reception. In certain configuration or situation, it is possible that only one of the MRB or DRB may be activated or may be received or may be operated. Further, there is also possibility for switching of the PDCP entity from the MBS-split bearer mode (as shown in new PDCP entity (800b)) to a legacy mode (as shown in legacy PDCP entity (800a)) and vice-versa. This can be performed through RRC reconfiguration message.

Further, multiple instances of functions corresponding to one or more deciphering, integrity protection and header decompression for one or more MRB and one or more DRB reception may exist when the UE (300) is operated in a Dual Active Protocol Stack (DAPS) mode for a source cell and a target cell.

In another embodiment, a mixed configuration of PDCP entity can be built from the legacy PDCP entity (800a) functions and the new PDCP entity (800b) functions of the source cell and the target cell and vice-versa. That is, functions for a DRB and functions for the MRB and the DRB are put together in the same PDCP entity.

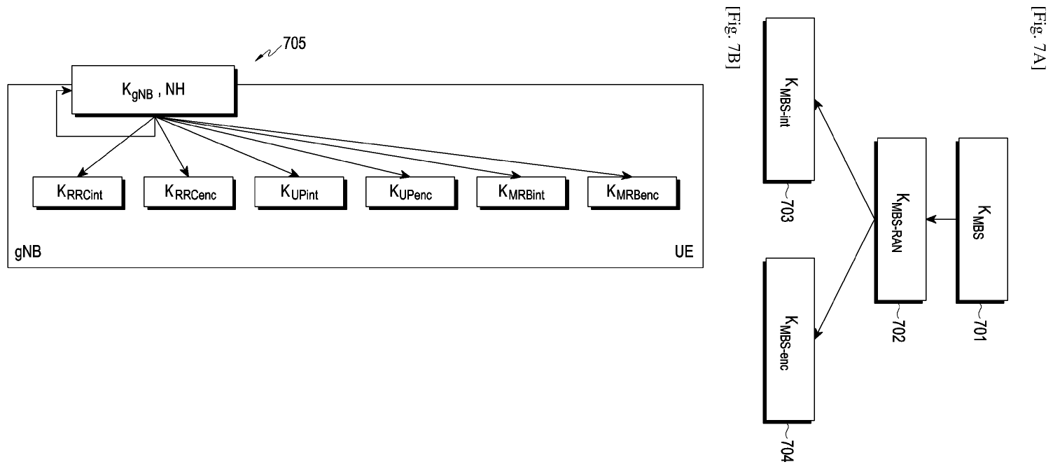

FIG. 9 is a sequence diagram illustrating the MBS counter check procedure between the UE (300) and the network entity (200) (e.g. NG-RAN (200a)), according to embodiments as disclosed herein.

In another embodiment, due to potentially large number of UEs receiving multicast/broadcast contents, the MBS counter check procedure can be applied selectively to a representative number of UEs (300) i.e. like sampling. At 901, the MBS counter check message is unicast/multicast/broadcast by the network entity (200). At 902 the MBS counter check response message is provided by the UEs (300) using a SRB or DRB or unicast uplink. Therefore, there can be enormous traffic on the reverse link (uplink) with the response messages from large number of UEs (300). The proposed method provides a mechanism to restrict the UEs (300) providing responses and includes some probability-based selection e.g. the UEs (300) are selected with uniformly distributed random number generation and the UEs (300) meeting conditions (e.g. random number generated above a threshold) will only respond to the MBS counter check.

In another embodiment, all the UEs (300) responds the MBS counter check message with the MBS counter check response message. In an embodiment, the procedure enables the network (200) to detect packet insertion by an intruder (a ‘man in the middle attack’).

Initiation: the network entity (200) initiates the procedure by sending the MBS counter check message. Note: The network entity (200) may initiate the procedure when any of the count values reaches a specific value. The MBS counter check message request and the corresponding response is being a new RRC message for MBS counter check or an enhanced Counter check message which carries the details of the MRB along with the DRB or a Counter Check message where the included RB ID is for MRB or DRB.

The reception of the MBS counter check message by the UE (300), upon receiving the MBS counter check message, the UE (300): for each DRB and/or MRB for MBS bearer that is established, assumes a count value to be 0 for an uplink direction for the uplink direction for MRB; then assumes the count value to be 0 for the uplink direction or the downlink direction when no COUNT exists for that direction for DRB; when the DRB-Identity and/or MRB-Identity is not included in the DRB-CountMSB-InfoList and/or MRB-CountMSB-InfoList, then the UE (300) includes the DRB in the drb-CountInfoList and/or MRB in the mrb-CountInfoList in the MBS counter check response message by including the DRB-Identity and corresponding the count-Uplink and the count-Downlink set to the value of TX_NEXT−1 and RX_NEXT−1, and/or MRB-Identity and the corresponding count-Downlink set to the value of RX_NEXT−1 (as specified in TS 38.323), respectively.

When the DRB-Identity and/or MRB-Identity is not included in the DRB-CountMSB-InfoList and/or MRB-CountMSB-InfoList, then the UE (300), when the most significant bits of the COUNT are different from the value indicated in the DRB-CountMSB-InfoList and/or MRB-CountMSB-InfoList, the UE (300) includes the DRB in the DRB-CountInfoList and/or MRB in the MRB-CountInfoList in the MBSCounterCheckResponse message by including the DRB-Identity, and the corresponding count-Downlink set to the value of TX_NEXT−1 and RX_NEXT−1 and/or MRB-Identity and the corresponding count-Downlink set to the value of RX_NEXT−1 (as specified in TS 38.323), respectively.

In an embodiment, for each DRB that is included in the DRB-CountMSB-InfoList and/or MRB that is included in the mrb-CountMSB-InfoList in the MBS counter check message that is not established, the UE (300) includes the DRB in the DRB-CountInfoList and/or MRB in the MRB-CountInfoList in the MBSCounterCheckResponse message by including the DRB-Identity, and the corresponding count-Uplink and count-Downlink and/or MRB-Identity and the corresponding count-Downlink with the most significant bits set identical to the corresponding values in the drb-CountMSB-InfoList and/or mrb-CountMSB-InfoList and the least significant bits set to zero; the UE (300) submit the MBS counter check response message to lower layers for transmission upon which the procedure ends.

For handling of the MBS key during state transition: For example, the transition from a CM-CONNECTED to a CM-IDLE. The CM-CONNECTED to CM-IDLE transitions and also applicable to a RRC-Connected to a RRC-Idle state transition.

In an embodiment, the gNB/ng-eNB (e.g. NG-RAN (200a)) and the UE (300) releases all radio bearers and delete an AS security context. Which means the PTM and/or PTP mode of transmission is no longer available for the MBS.

In an embodiment, the gNB/ng-eNB (e.g. NG-RAN (200a)) and the UE (300) does not release all PTM and/or PTP radio bearers and related security context. However, the gNB/ng-eNB (e.g. NG-RAN (200a)) and the UE (300) release all other radio bearers and delete the AS security context corresponding to other bearers.

In an embodiment, the gNB/ng-eNB (e.g. NG-RAN (200a)) and the UE (300) do not release all MRBs carrying the PTM MBS traffic and/or DRBs carrying the PTP MBS traffic, SRBs and related security context. However, the gNB/ng-eNB (e.g. NG-RAN (200a)) and the UE (300) release all other radio bearers and delete the AS security context corresponding to other bearers.

In an embodiment, in CM-IDLE mode, the gNB/ng-eNB (e.g. NG-RAN (200a)) and the UE (300) release all MRBs carrying the PTM MBS traffic and/or DRBs carrying the PTP MBS traffic, SRBs and related security context, once the MBS session(s) is completed.

In an embodiment, in CM-IDLE mode, the gNB/ng-eNB (e.g. NG-RAN (200a)) and the UE (300) release all MRBs carrying the PTM MBS traffic and/or DRBs carrying the PTP MBS traffic and SRBs, once the MBS session(s) is completed. The gNB/ng-eNB (e.g. NG-RAN (200a)) and the UE (300) keep the MBS security context data stored. In an embodiment, when the UE transit to RRC_INACTIVE state, the UE (300) suspends the MRB and MBS traffic reception and further, the UE (300) revives or restores the MBS security context when it is again moving to RRC connected state.

For State transition from a RRC_CONNECTED to a RRC_INACTIVE: the gNB/ng-eNB (e.g. NG-RAN (200a)) sends to the UE (300) an RRCRelease with a suspendConfig message that is ciphered and integrity protected in a PDCP layer using a current AS security context. The gNB/ng-eNB (e.g. NG-RAN (200a)) includes a fresh inactive-radio network temporary identifier (I-RNTI) I-RNTI, PTM MBS MRBs and/or PTP MBS DRBs to be kept active and a next hop chaining count (NCC) (or said NCC value) in that RRCRelease with suspendConfig message.

The gNB/ng-eNB (e.g. NG-RAN (200a)) deletes the current AS keys K_{RRCenc}, K_{UPenc} (if available), and K_{UPint} (if available) after sending the RRCRelease with the suspendConfig message to the UE (300), but shall keep the current AS key K_{RRC}int, K_{UPenc} (if in use by the MBS DRB(s)), and K_{UPint} (if in use by the MBS DRB(s)). The gNB/ng-eNB (e.g. NG-RAN (200a)) stores the sent I-RNTI together with the current UE context including the remainder of the AS security context (with security context required for the MBS PTP mode transmission).

Upon receiving a RRC Release with the suspendConfig message from the gNB/ng-eNB (e.g. NG-RAN (200a)), the UE (300) verifies that the integrity of the received RRCRelease with the suspendConfig message is correct by checking the PDCP MAC-I. If this verification is successful, then the UE (300) takes the received NCC value and saves it as stored NCC with the current UE context. The UE (300) deletes the current AS keys K_{RRCenc}, K_{UPenc} (if available), and K_{UPint} (if available), but keeps the current AS key K_{RRCint} key, K_{UPenc} (if in use by the MBS DRB(s)), and K_{UPint} (if in use by the MBS DRB(s)). If the stored NCC value is different from the NCC value associated with the current K_{gNB}, the UE (300) deletes the current AS key K_{gNB}. If the stored NCC is equal to the NCC value associated with the current K_{gNB}, the UE (300) keeps the current AS key K_{gNB}. The UE (300) stores the received I-RNTI together with the current UE context including the remainder of the AS security context (with security context required for the MBS PTP mode transmission), for the next state transition.

In an embodiment, the RRC_INACTIVE state allows the gNB/ng-eNB (e.g. NG-RAN (200a)) to suspend the UE's RRC connection while the gNB/ng-eNB (e.g. NG-RAN (200a)) and the UE (300) continues to maintain a UE 5G AS security context. The gNB/ng-eNB (e.g. NG-RAN (200a)) moves the MBS traffic transmission from PTP mode, if any, to the PTM mode before moving the UE (300) to RRC_INACTIVE state (if only MBS over DRB is active).

For key handling during mobility in RRC_INACTIVE state: RAN-based notification area update to a new (or same) gNB/ng-eNB (e.g. NG-RAN (200a)). When the UE (300) decides to initiate a RAN update (RANU) procedure the UE (300) may initiate the procedure with a new gNB/ng-eNB. The UE indicates the ongoing MBS session in PTM or/and PTP mode to a target gNB/ng-eNB (e.g. NG-RAN (200aa)).

The target gNB/ng-eNB shall check if it supports the ongoing MBS sessions with the UE (300) in the source cell. If the target gNB/ng-eNB prefers to change the mode of MBS transmission, then the target gNB/ng-eNB shall send an RRCSetup message on Signalling Radio Bearer with index zero (SRB0) to the UE (300) in order to proceed with RRC connection establishment as if the UE (300) was in RRC_IDLE (i.e., fall back procedure) to change the mode.

The target gNB/ng-eNB shall check if it supports the ongoing MBS sessions with the UE (300) in the source cell. If the target gNB/ng-eNB does not support the MBS sessions used in the last source cell, then the target gNB/ng-eNB shall send an RRC message on SRB0 to the UE (300) to indicate the non-support of the MBS sessions.

If the target gNB/ng-eNB supports the MBS session(s) which the UE (300) receiving with the last source cell and the target gNB/ng-eNB decides to send the UE (300) directly back to RRC_INACTIVE state without bringing the UE (300) to RRC_CONNECTED state, the target gNB/ng-eNB shall perform a path switch procedure with the AMF (200b) to get a fresh {NCC, NH} pair before sending the RRCRelease message to the UE. After the target gNB/ng-eNB receives a fresh {NCC, NH} pair in a path switch acknowledgement message from the AMF (200b), the target gNB/ng-eNB shall set the value of NCC in the RRCRelease message to the NCC value of the received fresh {NCC, NH} pair and includes the MBS security context data of the TMGI(s) for the ongoing MBS sessions.

After the source gNB/ng-eNB (old gNB/ng-eNB) validates the ResumeMAC-I/shortResumeMAC-I received from the target gNB/ng-eNB (new gNB/ng-eNB) in a retrieve UE context request message, the old gNB/ng-eNB shall not decide to not to relocate the UE context to the new gNB/ng-eNB.

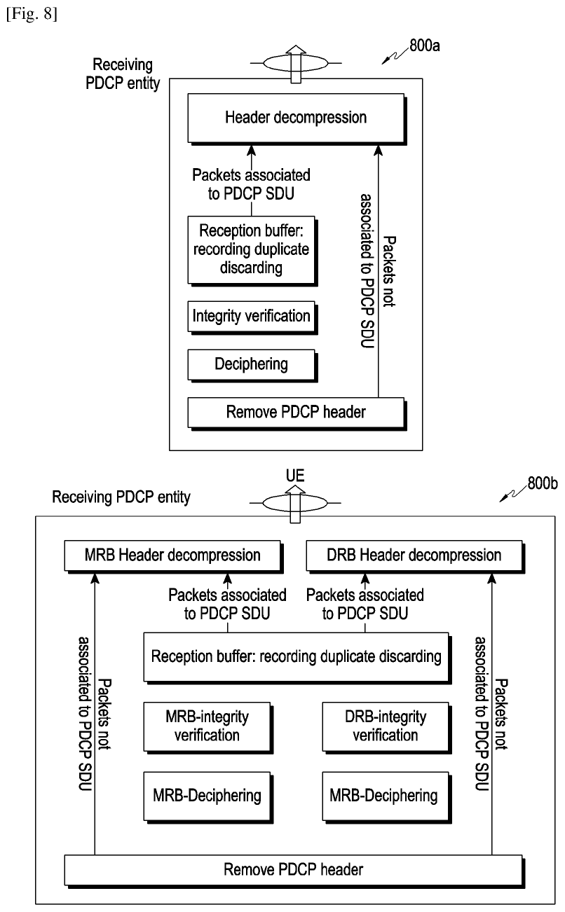

FIG. 10 is another sequence diagram illustrating the MBS counter check procedure between the UE (300) and the network entity (200), according to embodiments as disclosed herein.

At 1001, the UE (300) receives indication from upper layers. At 1002, the UE (300) sends an MBS counter check message to the network entity (200) (e.g. NG-RAN (200a)) of the plurality of network entities, where the MBS counter check message includes the amount of data sent and/or received on each DRB and/or each MRB. Alternatively, the UE (300) sends an MBS counter check message to the network entity (200) (e.g. NG-RAN (200a)) of the plurality of network entities, where the MBS counter check message includes radio bearer identities that needs the counter check. At 1003, the UE (300) receives an MBS counter check response message from the network entity (200), where the MBS counter check response message includes the amount of data sent and/or received on each DRB and/or sent on each MRB from the network entity (200). At 1004, the UE (300) determines whether the amount of data sent and/or received on each DRB and/or received on each MRB by the UE (300) is the same as the amount of data received and/or sent on each DRB and/or sent on each MRB by the network entity (200). The UE (300) detects that the man-in-middle attack in response to determining that the amount of data sent and/or received on each DRB and/or received on each MRB by the UE (300) is not the same as the amount of data received and/or sent on each DRB and/or sent on each MRB by the network entity (200) and the UE (300) may initiate re-establishment procedure for the MBS.

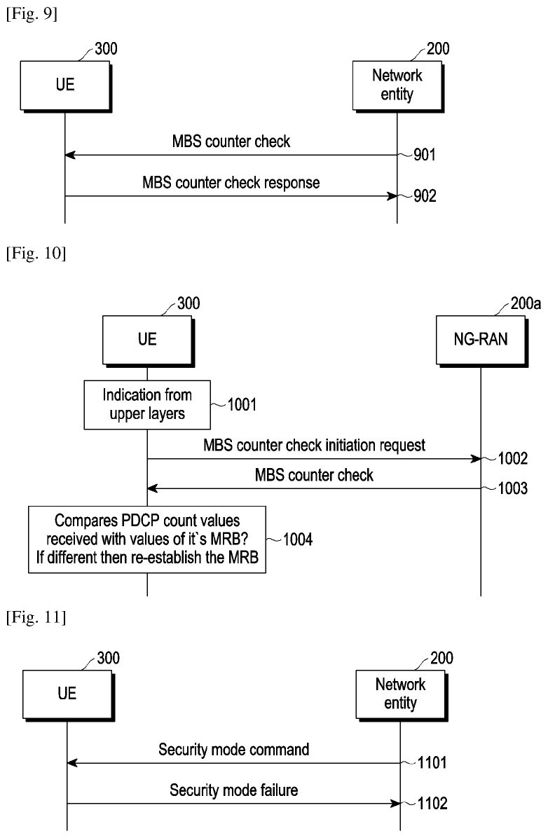

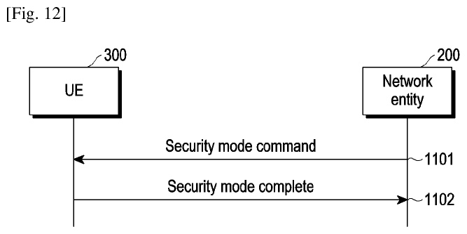

FIGS. 11-12 are sequence diagrams illustrating the security mode command procedure between the UE (300) and the network entity (200) is to activate AS security upon the RRC connection establishment, according to embodiments as disclosed herein.

On reception of the security mode command by the UE (300) from the network entity (200), the UE (300) derives the K_{gNB} key, as specified in TS 33.501. The UE (300) then derives the K_{RRC}int key associated with an integrityProtmechanism indicated in the security mode command message (1101 and 1201), as specified in TS 33.501. The UE (300) then request lower layers to verify the integrity protection of the security mode command message (1101 and 1201), using the mechanism indicated by the integrityProtmechanism as included in the security mode command message (1101 and 1201) and the K_{RRCint} key.

If the security mode command message (1201) passes the integrity protection check, the UE (300) then derives the K_{RRCenc} key and the K_{UPenc} key associated with a cipheringmechanism indicated in the security mode command message (1201), as specified in TS 33.501. The UE (300) then derives the K_{UPint} key associated with the integrityProtmechanism indicated in the security mode command message (1201), as specified in TS 33.501.

In an embodiment, it is possible when the UE (300) comes to connected state form Idle/Inactive only for receiving multicast data and it need to be configured with MBS key in the SMC itself (and not in two steps (i.e. by a following up RRC reconfiguration). In this case, the NG-RAN (200a) provides the MBS security context as part of the SMC procedure and UE derive the K_{MRBint} and/or K_{MRBenc} and/or K_{MRBsec}.

In an embodiment, the MBS security context is encrypted by the NG-RAN (200a). The UE (300) then configures the lower layers to apply SRB integrity protection using the indicated mechanism and the K_{RRC}int key immediately, i.e. integrity protection shall be applied to all subsequent messages received and sent by the UE, including the security mode complete message (1202). The UE (300) then configures the lower layers to apply SRB ciphering using the indicated mechanism, the K_{RRCenc} key after completing the procedure, i.e. ciphering shall be applied to all subsequent messages received and sent by the UE (300), except for the security mode complete message (1202) which is sent unciphered. The UE (300) then considers AS security to be activated. The UE (300) then submits the security mode complete message (1202) to lower layers for transmission, upon which the procedure ends.

If the security mode command message (1101) does not passes the integrity protection check, the UE (300) then continues using the configuration used prior to the reception of the security mode command message (1101), i.e. neither apply integrity protection nor ciphering. The UE (300) then submit a security mode failure message (1102) to lower layers for transmission, upon which the procedure ends.

The embodiments disclosed herein can be implemented using at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method for handling key distribution for multicast and broadcast services (MBS) in a wireless network, the method comprising:
sending, by an application function (AF) server, a multicast and broadcast (MB) session announcement message to a user equipment (UE) in the wireless network, wherein the MB session announcement message comprises at least one of a temporary mobile group identity (TMGI) and a higher layer IP multicast address (HL MC address);
generating, by the AF server, a session key (K_{MBS}) for the TMGI and the HL MC address, wherein the session key (K_{MBS}) is provided to at least one of the UE and a plurality of network entities; and
protecting, by the AF server, a MBS traffic associated with the at least one of the UE and the plurality of network entities based on the generated session key (K_{MBS}).

2. The method of claim 1,
wherein the plurality of network entities comprises at least one of an next generation radio access network (NG-RAN) (200a), an access and mobility management function (AMF), an MB-session management function (MB-SMF), an MB-user plane function (MB-UPF), a policy control function (PCF), a network exposure function (NEF), and an NF repository function (NRF),
wherein generating the session key (K_{MBS}) comprises: generating, by a key management server (KMS), the K_{MBS}, wherein the KMS is colocated with at least one of the NEF, the NG-RAN, the AMF, the MB-SMF, the AF, and a standalone entity within a 5G-core (5GC) or outside of the 5GC, and
wherein the KMS is discoverable by the plurality of network entities using the NRF, and the plurality of network entities obtain the session key (K_{MBS}) from the KMS by exchanging a key request message and a key response message.

3. The method of claim 1,
wherein the at least one of the UE and the plurality of network entities generates a plurality of keys using the session key (K_{MBS}) to secure the MBS traffic, and the plurality of keys comprises at least one of an MBS RAN specific key (K_{MBS-RAN}), an MBS integrity key (K_{MBSint}), an MBS encrypted key (K_{MBSenc}), and an MBS security key (K_{MBSsec}),
wherein the K_{MBS-RAN} is generated by at least one of the UE and the NG-RAN from the session key (K_{MBS}) and a plurality of parameters, and the plurality of parameters comprises at least one of the TMGI, a count of MBS, a physical cell identifier (PCI), a down link (DL) frequency, and a random number (RAND),
wherein the K_{MBSint} is generated by the at least one of the UE and the NG-RAN from at least one of the session key (K_{MBS}), the K_{MBS-RAN}, and the plurality of parameters for MBS traffic protection using a specific integrity protocol.

4. The method of claim 3, wherein the K_{MBSenc} is generated by the at least one of the UE and the NG-RAN from at least one of the session key (K_{MBS}), the K_{MBS-RAN}, and the plurality of parameters.

5. The method of claim 3, wherein the K_{MBSsec} is generated by the at least one of the UE and the NG-RAN from at least one of the session key (K_{MBS}), the K_{MBS-RAN}, and the plurality of parameters.

6. The method of claim 1, wherein the method further comprises:
updating, by the AF server, the session key (K_{MBS}) for an ongoing MBS session; and
sending, by the AF server, a message to the NG-RAN through one or more network entity of the plurality of network entities, wherein the message indicates that the session key (K_{MBS}) is changed for ongoing MBS session and the NG-RAN sends the message to the UE in at least one of a system information block (SIB), a MBS multicast control channel (MCCH) information message or a RRC reconfiguration message,
wherein the message comprises at least one of a new TMGI, a new session key index for corresponding TMGI, and a selected protocol for corresponding TMGI.

7. The method of claim 1, wherein the method further comprises:
determining, by the AF server, whether security protection applies to an ongoing MBS session and an indication is present in an MBS security context, wherein the indication indicates that whether or not security protection applies to the ongoing MBS session;
inserting, by the AF server, security related parameters in the MBS security context in response to determining that the security protection applies to the ongoing MBS session and the indication is present in an MBS security context, wherein the indication indicates that the security protection applies to the ongoing MBS session; and
sending, by the AF server, the MBS security context to the UE through one or more network entity of the plurality of network entities.

8. The method of claim 1, wherein the method further comprises:
determining, by the AF server, whether security protection applies to an ongoing MBS session; and
sending, by the AF server, the MBS security context to the UE through one or more network entity of the plurality of network entities in response to determining that the security protection applies to the ongoing MBS session.

9. The method of claim 1, wherein the method further comprises:
storing, by the UE, a MBS security context in a memory, when the UE is in an idle mode or a connection-mode or switch between modes.

10. The method of claim 1, wherein the method further comprises:
sending, by a network entity of the plurality of network entities, an MBS counter check message to the UE, wherein the MBS counter check message comprises an indication for an amount of data sent or received on each established data radio bearer (DRB) and/or an indication for an amount of data sent on each MBS radio bearer (MRB), wherein the network entity comprises the NG-RAN and wherein MBS bearer can be one of PTM bearer, PTP bearer or a split MBS bearer;
receiving, by the network entity, an MBS counter check response message from the UE, wherein the MBS counter check response message comprises an amount of data received or sent on each DRB and/or an amount of data received on each MRB from the UE;
determining, by the network entity, whether the amount of data sent or received on each DRB and/or sent on each MRB by the network entity is the same as the amount of data received or sent on each DRB and/or the amount of data received on each MRB by the UE; and
detecting, by the network entity, a man in the middle attack in response to determining that the amount of data sent or received on each DRB and/or the amount of data received on each MRB by the network entity is not the same as the amount of data received or sent on each DRB and/or the amount of data received on each MRB by the UE; and
re-establishing, by the network entity, the MBS, wherein the MBS is a combination of a point to multipoint (PTM) and a point to point (PTP).

11. The method of claim 1, wherein the method further comprises:
selecting, by the network entity, randomly limited number of UEs in connected mode from a plurality of UEs accessing an ongoing MBS session, wherein the network entity comprises the NG-RAN; and
sending, by the network entity, an MBS counter check message to the selected UE, as to restrict the plurality of UEs providing responses.

12. The method of claim 1, wherein the method further comprises:
sending, by the UE, an MBS counter check message to a network entity of the plurality of network entities, wherein the MBS counter check message comprises an amount of data sent or received on each DRB and/or an amount of data received on each MRB, and wherein the network entity comprises the NG-RAN;
receiving, by the UE, an MBS counter check response message from the network entity, wherein the MBS counter check response message comprises an indication for an amount of data received or sent on each DRB and/or an indication for an amount of data sent on each MRB from the network entity;
determining, by the UE, whether the amount of data received or sent on each DRB and/or the amount of data received on each MRB is same as the amount of data sent or received by the network entity on each DRB and/or the amount of data sent by the network entity on each MRB; and
detecting, by the UE, a man-in-middle attack in response to determining that the amount of data sent or received on each DRB and/or the amount of data received on each MRB by the UE is not the same as the amount of data received or sent on each DRB and/or the amount of data sent on each MRB from the network entity; and
re-establishing, by the UE, the MBS.

13. An application function (AF) server for handling key distribution for multicast and broadcast services (MBS) in a wireless network, the AF server comprising:
a memory;
a processor; and
an MBS session key controller, operably connected to the memory and the processor, configured to:
send a multicast and broadcast (MB) session announcement message to a user equipment (UE) in the wireless network, wherein the MB session announcement message comprises at least one of a temporary mobile croup identity (TMGI) and a higher layer IP multicast address (HL MC address);
generate a session key (KMBS) for the TMGI and the HL MC address, wherein the session key (KMBS) is provided to at least one of the UE and a plurality of network entities; and
protect a MBS traffic associated with the at least one of the UE and the plurality of network entities using the generated session key (KMBS).

14. A network entity for handling key distribution for multicast and broadcast services (MBS) in a wireless network, the network entity comprising:
a memory;
a processor; and
an MBS session key controller, operably connected to the memory and the processor, configured to:
receive a session key (K_{MBS}) from an application function (AF) server;
generate a plurality of keys using the session key (K_{MBS}) to protect a MBS traffic, wherein the plurality of keys comprises at least one of an MBS RAN specific key (K_{MBS-RAN}), an MBS integrity key (K_{MBSint}), an MBS encrypted key (K_{MBSenc}), and an MBS security key (K_{MBSsec}).

15. A user equipment (UE) for handling key distribution for multicast and broadcast services (MBS) in a wireless network, the UE (300) comprising:
a memory;
a processor; and
an MBS session key controller, operably connected to the memory and the processor, configured to:
receive a session key (K_{MBS}) from an application function (AF) server;
generate a plurality of keys using the session key (K_{MBS}) to protect a MBS traffic, wherein the plurality of keys comprises at least one of an MBS RAN specific key (K_{MBS-RAN}), an MBS integrity key (K_{MBSint}), an MBS encrypted key (K_{MBSenc}), and an MBS security key (K_{MBSsec}).
